(19) United States
(12) Patent Application Publication
(10) Pub. No.: US 2025/0168878 A1
(43) Pub. Date: May 22, 2025

(54) PROCESSING METHOD, COMMUNICATION DEVICE AND STORAGE MEDIUM

(71) Applicant: SHENZHEN TRANSSION HOLDINGS CO., LTD., Shenzhen (CN)

(72) Inventors: Chiunwei HUANG, Shenzhen (CN); Rongchang ZHU, Shenzhen (CN); Wei HUANG, Shenzhen (CN)

(73) Assignee: SHENZHEN TRANSSION HOLDINGS CO., LTD., Shenzhen (CN)

(21) Appl. No.: 19/031,011

(22) Filed: Jan. 17, 2025

Related U.S. Application Data
(63) Continuation of application No. PCT/CN2022/116564, filed on Sep. 1, 2022.

(51) Int. Cl. H04W 74/0808

(52) U.S. Cl. CPC H04W 74/0808

(57) ABSTRACT

Disclosed are a processing method, a communication device and a storage medium. The communication device determines the contention window size according to the channel state within the first reference duration and/or the feedback information received within the second reference duration. In the case of no HARQ feedback of the physical sidelink shared channel or in the case of only NACK feedback of the physical sidelink shared channel or in the case of a non-control/data channel, after the random backoff mechanism is started, the contention window size is determined according to the channel state within the first reference duration and/or the feedback information received within the second reference duration, so as to adjust the contention window size according to the occupancy of the channel and the information transmission situation, thereby realizing adaptive adjustment of the contention window size in the random backoff mechanism, and avoiding communication conflicts between multiple communication devices.

### CROSS-REFERENCE TO RELATED APPLICATIONS

This application is a continuation application of International Application No. PCT/CN2022/116564, filed on Sep. 1, 2022, the content of which is incorporated herein by reference in its entirety.

### TECHNICAL FIELD

The present application relates to the technical field of communication, and in particular to a processing method, a communication device and a storage medium.

### BACKGROUND

In New Radio in Unlicensed Spectrum (NR-U), a random backoff mechanism is introduced to avoid conflicts between multiple transmitters. The random backoff process first initializes the backoff counter with a random number in the contention window (CW). The random number comes from a uniform distribution [0, CW] and represents the duration that the transmission channel must remain idle in multiples of 9 μs. The larger the contention window, the larger the average backoff value and the lower the probability of conflict.

The contention window size can be adjusted to adapt to the idle state of the channel. In NR-U, the contention window size is adjusted dynamically based on the Hybrid Automatic Repeat reQuest (HARQ) feedback for the data channel. However, for situations where there is no HARQ feedback for the data channel or only HARQ-Negative Acknowledgement (NACK) feedback for the data channel or non-control/data channels or HARQ feedback(s) for groupcast channel, the contention window size in the random backoff mechanism cannot be adjusted adaptively, which can easily cause communication conflicts between multiple transmitters.

The preceding description is intended to provide general background information and does not necessarily constitute related art.

### SUMMARY

In view of the above technical problems, the present application provides a processing method, a communication device and a storage medium to solve the technical problem that the contention window size cannot be adjusted adaptively and easily causes communication conflicts between multiple transmitters.

In order to solve the above technical problem, in a first aspect, the present application provides a processing method, which can be applied to a communication device (such as a terminal device, specifically a mobile phone), including the following steps:
determining a contention window size according to a channel state within a first reference duration and/or feedback information received within a second reference duration.

In an embodiment, the channel state includes at least one of the following: Listen Before Talk (LBT) success, LBT failure, a ratio of LBT failures, and a ratio of sensing slots of busy channels; and the feedback information includes at least one of the following: a number of NACK feedbacks, a ratio of NACK feedbacks, a number of ACK feedbacks, and a ratio of ACK feedbacks.

In an embodiment, the determining the contention window size according to the channel state within the first reference duration and/or the feedback information received within the second reference duration includes at least one of the following:
in response to that there is no HARQ feedback for a physical sidelink shared channel, adjusting or maintaining the contention window size according to the channel state within the first reference duration; and
in response to that only HARQ-NACK feedback information is received, adjusting the contention window size according to the HARQ-NACK feedback information received within the second reference duration.

In an embodiment, the method further includes at least one of the following:
in response to that LBT fails within the first reference duration, increasing the contention window size;
in response to that the ratio of LBT failures within the first reference duration is greater than a first threshold value, increasing the contention window size;
in response to that the ratio of the sensing slots of busy channels within the first reference duration is greater than a second threshold value, increasing the contention window size;
in response to that LBT succeeds within the first reference duration, maintaining the contention window size, or configuring the contention window size to a minimum contention window size adapted to a channel access priority class;
in response to that the ratio of LBT failures within the first reference duration is less than or equal to the first threshold value, maintaining the contention window size, or configuring the contention window size to the minimum contention window size adapted to the channel access priority class;
in response to that the ratio of the sensing slots of the busy channels within the first reference duration is less than or equal to the second threshold value, maintaining the contention window size, or configuring the contention window size to the minimum contention window size adapted to the channel access priority class;
in response to that the number of NACK feedbacks received within the second reference duration is greater than a fourth threshold value, increasing the contention window size;
in response to that the number of NACK feedbacks received within the second reference duration is less than or equal to the fourth threshold value, maintaining the contention window size, or configuring the contention window size to the minimum contention window size adapted to the channel access priority class;
in response to that the ratio of NACK feedbacks received within the second reference duration is greater than a fifth threshold value, increasing the contention window size; and
in response to that the ratio of NACK feedbacks received within the second reference duration is less than or equal to the fifth threshold value, maintaining the contention window size, or configuring the contention window size to the minimum contention window size adapted to the channel access priority class.

In an embodiment, the configuring the contention window size to the minimum contention window size adapted to the channel access priority class includes at least one of the following:
configuring the contention window size to the minimum contention window size of each channel access priority class;
configuring the contention window size to the minimum contention window size of a random channel access priority class;
configuring the contention window size to the contention window size determined by a channel access priority class of a communication device;
configuring the contention window size to the contention window size determined by a channel access priority class of a receiving terminal;
configuring the contention window size to the contention window size determined by a minimum channel access priority class of the receiving terminal;
configuring the contention window size to the contention window size determined by a maximum channel access priority class of the receiving terminal;
configuring the contention window size to the contention window size determined by a random channel access priority class of the receiving terminal; and
configuring the contention window size to the contention window size determined by a channel access priority class corresponding to per-packet priority of near field communication.

In an embodiment, the method further includes at least one of the following:
in response to that an interval between the first reference duration and the currently expected Channel Occupancy Time (COT) is greater than a third threshold value, maintaining the contention window size, or configuring the contention window size to the minimum contention window size adapted to the channel access priority class;
in response to that the interval between the first reference duration and the currently expected COT is less than or equal to the third threshold value, adjusting the contention window size according to the channel state;
in response to that an interval between the second reference duration and the currently expected COT is greater than a sixth threshold value, maintaining the contention window size, or configuring the contention window size to the minimum contention window size adapted to the channel access priority class;
in response to that the interval between the second reference duration and the currently expected COT is less than or equal to the sixth threshold value, adjusting the contention window size according to the received feedback information; and
in response to that a communication device performs a first transmission in an unlicensed spectrum, maintaining the contention window size, or configuring the contention window size to the minimum contention window size adapted to the channel access priority class.

In an embodiment, a way for determining the first reference duration includes at least one of the following:
determining the first reference duration by COT position where the most recent transmission is located;
determining the first reference duration by at least one candidate position of the first transmission within the COT where the most recent transmission is located;
determining the first reference duration by N sensing slots corresponding to the contention window associated with the COT where the most recent transmission is located;
determining the first reference duration by the COT position associated with the most recent contention window size update; and
determining the first reference duration by the COT position where the most recent transmission with HARQ feedback enabled;
a way for determining the second reference duration includes at least one of the following:
determining the second reference duration by COT position where the most recent transmission is located;
determining the second reference duration by the COT position associated with the most recent contention window size update; and
determining the second reference duration by the COT position where the most recent transmission with HARQ feedback enabled.

The present application further provides a communication device, including: a memory, a processor, and a processing program stored in the memory and executable on the processor, and the processing program implements the steps of the processing method as described above when executed by the processor.

The present application further provides a storage medium, a computer program is stored in the storage medium, and when the computer program is executed by a processor, the steps of the processing method as described above are implemented.

The present application further provides a communication apparatus, including: a processing unit for determining a contention window size according to a channel state within a first reference duration and/or feedback information received within a second reference duration.

In an embodiment, the processing unit is further configured for implementing at least one of the following: the channel state includes at least one of the following: LBT success, LBT failure, a ratio of LBT failures, and a ratio of sensing slots of busy channels; and the feedback information includes at least one of the following: a number of NACK feedbacks, a ratio of NACK feedbacks, a number of ACK feedbacks, and a ratio of ACK feedbacks.

In an embodiment, the processing unit is further configured for implementing at least one of the following:
in response to that there is no HARQ feedback for a physical sidelink shared channel, adjusting or maintaining the contention window size according to the channel state within the first reference duration; and
in response to that only HARQ-NACK feedback information is received, adjusting the contention window size according to the HARQ-NACK feedback information received within the second reference duration.

In an embodiment, the processing unit is further configured for implementing at least one of the following:
in response to that LBT fails within the first reference duration, increasing the contention window size;
in response to that the ratio of LBT failures within the first reference duration is greater than a first threshold value, increasing the contention window size;
in response to that the ratio of the sensing slots of busy channels within the first reference duration is greater than a second threshold value, increasing the contention window size;
in response to that LBT succeeds within the first reference duration, maintaining the contention window size, or configuring the contention window size to a minimum contention window size adapted to a channel access priority class;
in response to that the ratio of LBT failures within the first reference duration is less than or equal to the first threshold value, maintaining the contention window size, or configuring the contention window size to the minimum contention window size adapted to the channel access priority class;
in response to that the ratio of the sensing slots of the busy channels within the first reference duration is less than or equal to the second threshold value, maintaining the contention window size, or configuring the contention window size to the minimum contention window size adapted to the channel access priority class;
in response to that the number of NACK feedbacks received within the second reference duration is greater than a fourth threshold value, increasing the contention window size;
in response to that the number of NACK feedbacks received within the second reference duration is less than or equal to the fourth threshold value, maintaining the contention window size, or configuring the contention window size to the minimum contention window size adapted to the channel access priority class;
in response to that the ratio of NACK feedbacks received within the second reference duration is greater than a fifth threshold value, increasing the contention window size; and
in response to that the ratio of NACK feedbacks received within the second reference duration is less than or equal to the fifth threshold value, maintaining the contention window size, or configuring the contention window size to the minimum contention window size adapted to the channel access priority class.

In an embodiment, the configuring the contention window size to the minimum contention window size adapted to the channel access priority class includes at least one of the following:
configuring the contention window size to the minimum contention window size of each channel access priority class;
configuring the contention window size to the minimum contention window size of a random channel access priority class;
configuring the contention window size to the contention window size determined by a channel access priority class of a communication device;
configuring the contention window size to the contention window size determined by a channel access priority class of a receiving terminal;
configuring the contention window size to the contention window size determined by a minimum channel access priority class of the receiving terminal;
configuring the contention window size to the contention window size determined by a maximum channel access priority class of the receiving terminal;
configuring the contention window size to the contention window size determined by a random channel access priority class of the receiving terminal; and
configuring the contention window size to the contention window size determined by a channel access priority class corresponding to per-packet priority of near field communication.

In an embodiment, the processing unit is further configured for implementing at least one of the following:
in response to that an interval between the first reference duration and the currently expected COT is greater than a third threshold value, maintaining the contention window size, or configuring the contention window size to the minimum contention window size adapted to the channel access priority class;
in response to that the interval between the first reference duration and the currently expected COT is less than or equal to the third threshold value, adjusting the contention window size according to the channel state;
in response to that an interval between the second reference duration and the currently expected COT is greater than a sixth threshold value, maintaining the contention window size, or configuring the contention window size to the minimum contention window size adapted to the channel access priority class;
in response to that the interval between the second reference duration and the currently expected COT is less than or equal to the sixth threshold value, adjusting the contention window size according to the received feedback information; and
in response to that a communication device performs a first transmission in an unlicensed spectrum, maintaining the contention window size, or configuring the contention window size to the minimum contention window size adapted to the channel access priority class.

In an embodiment, the processing unit is further configured for implementing at least one of the following:
a way for determining the first reference duration includes at least one of the following:
determining the first reference duration by COT position where the most recent transmission is located;
determining the first reference duration by at least one candidate position of the first transmission within the COT where the most recent transmission is located;
determining the first reference duration by N sensing slots corresponding to the contention window associated with the COT where the most recent transmission is located;
determining the first reference duration by the COT position associated with the most recent contention window size update; and
determining the first reference duration by the COT position where the most recent transmission with HARQ feedback enabled;
a way for determining the second reference duration includes at least one of the following:
determining the second reference duration by COT position where the most recent transmission is located;
determining the second reference duration by the COT position associated with the most recent contention window size update; and
determining the second reference duration by the COT position where the most recent transmission with HARQ feedback enabled.

As described above, the present application provides a processing method, a communication device and a storage medium, which can be applied to a communication device (such as a mobile phone). The communication device determines the contention window size according to a channel state within a first reference duration and/or feedback information received within a second reference duration. In an embodiment of the present application, in the case of no HARQ feedback of the physical sidelink shared channel or in the case of only NACK feedback of the physical sidelink shared channel or in the case of non-control/physical sidelink shared channel, after the random backoff mechanism is started, the contention window size is determined according to the channel state within the first reference duration and/or the feedback information received within the second reference duration, such that the contention window size is adjusted according to the channel occupancy and information transmission conditions, and the contention window size in the random backoff mechanism is adaptively adjusted to avoid communication conflicts between multiple communication devices.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic diagram of hardware structure of a terminal for implementing various embodiments of the present application according to an embodiment of the present application.

FIG. 2 is a diagram of architecture of a communication network system according to an embodiment of the present application.

FIG. 3 is a flowchart of a processing method according to an embodiment of the present application.

FIG. 4 is a flowchart of a communication device starting a random backoff process according to an embodiment of the present application.

FIG. 5 is a flowchart of a processing method according to another embodiment of the present application.

FIG. 6 is a flowchart of a processing method according to another embodiment of the present application.

FIG. 7 is a flowchart of a processing method according to another embodiment of the present application.

FIG. 8 is a flowchart of a processing method according to another embodiment of the present application.

FIG. 9 is a schematic diagram of a scenario in which the first reference duration is determined by the most recently transmitted COT position according to an embodiment of the present application.

FIG. 10 is a flowchart of a processing method according to another embodiment of the present application.

FIG. 11 is a flowchart of a processing method according to another embodiment of the present application.

FIG. 12 is a flowchart of a processing method according to another embodiment of the present application.

FIG. 13 is a schematic diagram of another scenario in which the first reference duration is determined by the most recently transmitted COT position according to an embodiment of the present application.

FIG. 14 is a flowchart of a processing method according to another embodiment of the present application.

FIG. 15 is a flowchart of a processing method according to another embodiment of the present application.

FIG. 16 is a flowchart of a processing method according to another embodiment of the present application.

FIG. 17 is a schematic diagram of the distribution of N idle channels in a random backoff contention window according to an embodiment of the present application.

FIG. 18 is a flowchart of a processing method according to another embodiment of the present application.

FIG. 19 is a flowchart of a processing method according to another embodiment of the present application.

FIG. 20 is a flowchart of a processing method according to another embodiment of the present application.

FIG. 21 is a flowchart of a processing method according to another embodiment of the present application.

FIG. 22 is a flowchart of a processing method according to another embodiment of the present application.

FIG. 23 is a flowchart of a processing method according to another embodiment of the present application.

FIG. 24 is a flowchart of a processing method according to another embodiment of the present application.

FIG. 25 is a schematic structural diagram of a communication apparatus according to an embodiment of the present application.

FIG. 26 is a schematic structural diagram of another communication device according to an embodiment of the present application.

FIG. 27 is a schematic diagram of hardware structure of a controller 140 according to an embodiment of the present application.

FIG. 28 is a schematic diagram of hardware structure of a network node 150 according to an embodiment of the present application.

The realization of the purpose, functional features and advantages of the present application will be further described with reference to the embodiments and the accompanying drawings. Through the above-mentioned drawings, clear embodiments of the present application have been shown, which will be described in more detail below. These drawings and text descriptions are not intended to limit the scope of the present application's concepts in any way, but are intended to illustrate the present application's concepts for those skilled in the art with reference to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S1 and S2 are used for the purpose of expressing the corresponding content more clearly and concisely, and do not constitute a substantive limitation on the order. Those skilled in the art may perform S2 first and then S1 etc. during specific implementation, but these should all be within the protection scope of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context.

In an embodiment, the terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

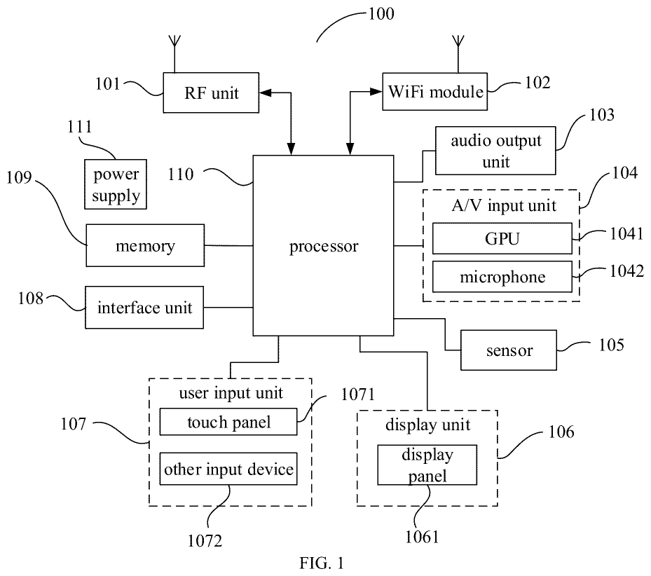

As shown in FIG. 1, FIG. 1 is a schematic structural diagram of a hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a recording mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a recording mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switching, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated here.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and sends it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

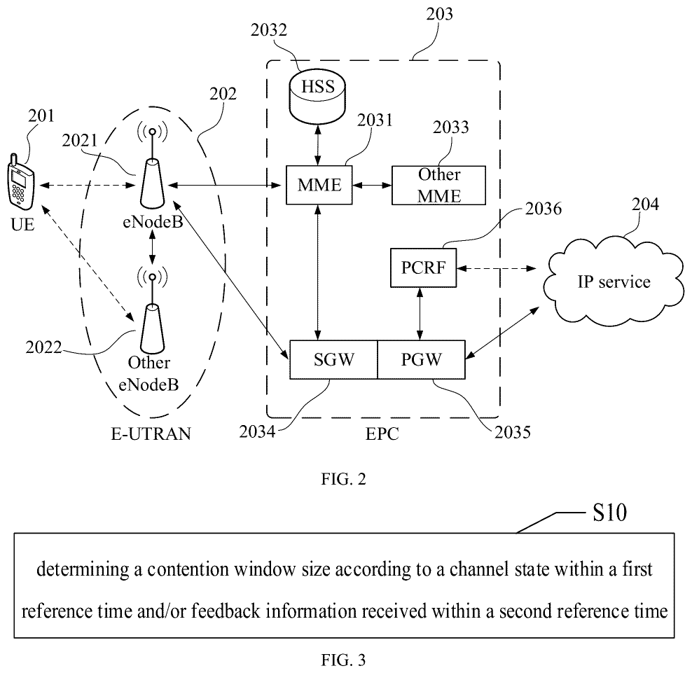

As shown in FIG. 2, FIG. 2 is an architecture diagram of a communication network system according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

In an embodiment, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

Based on the above hardware structure of the mobile terminal and communication network system, various embodiments of the present application are proposed.

Please referring to FIG. 3, which is a flowchart of a processing method according to an embodiment of the present application. The method of the embodiment of the present application can be executed by a communication device. In a first embodiment of the processing method of the present application, the method may include the following steps:

S10, determining a contention window size according to a channel state within a first reference duration and/or feedback information received within a second reference duration.

In some embodiments of the present application, the processing method is applied to the adjustment of the sidelink contention window. In NR-U/License Assisted Access (LAA), the contention window size can be dynamically adjusted according to the HARQ feedback of the data channel. For scenarios where there is no HARQ feedback for the physical sidelink shared channel or only HARQ-NACK feedback for the physical sidelink shared channel, the current random backoff mechanism based on the contention window is not available.

In some embodiments, the first reference duration is determined by the associated position of the Channel Occupancy Time (COT) where the most recent transmission is located, for example, the first reference duration is determined by the COT position where the most recent transmission is located, or the first reference duration is determined by at least one candidate position of the first transmission within the COT where the most recent transmission is located, or the first reference duration is determined by N sensing slots corresponding to the contention window associated with the COT where the most recent transmission is located, N is a positive integer, or the first reference duration is determined by the COT position associated with the most recent contention window size update, or the first reference duration is determined by the COT position where the most recent transmission with HARQ feedback enabled.

In some embodiments, the second reference duration is determined by the associated position of the COT where the most recent transmission is located, for example, the second reference duration is determined by the COT position where the most recent transmission is located, or the second reference duration is determined by the COT position associated with the most recent contention window size update, or the second reference duration is determined by the COT position where the most recent transmission with HARQ feedback enabled.

In some embodiments, the COT where the most recent transmission is located is the COT occupied by the most recent transmission to this transmission.

In some embodiments, the COT associated with the most recent contention window size update is the COT occupied by the most recent transmission to this transmission, and the corresponding contention window size is updated during the channel access process used by the corresponding transmission.

In some embodiments, the most recently transmitted COT with HARQ feedback enabled is a COT including HARQ-enabled Physical Sidelink Share Channel (PSSCH) channel transmission; that is, the PSSCH transmitted in the COT has associated HARQ feedback; or the Physical Sidelink Control Channel (PSCCH) of the scheduled PSSCH transmitted in the COT indicates HARQ feedback enabled.

In some embodiments, the channel state includes one or more of listen before talk (LBT) success, LBT failure, the ratio of LBT failures, and the ratio of sensing slots of busy channels. The channel state is mainly used to describe the busyness and occupancy of the current channel. The channel state within the first reference duration is an important basis for determining the contention window size.

In some embodiments, the feedback information includes one or more of the number of NACK feedbacks, the ratio of NACK feedbacks, the number of ACK feedbacks, and the ratio of ACK feedbacks. The feedback information is mainly used to describe the information transmission status of the current channel. The feedback information received within the second reference duration is an important basis for determining the contention window size.

In some embodiments, the step of determining the contention window size according to the channel state within the first reference duration in step S10 includes: if there is no HARQ feedback for the physical sidelink shared channel, adjusting the contention window size or maintaining the contention window size according to the channel state within the first reference duration.

In some embodiments, the step of determining the contention window size according to the feedback information received within the second reference duration includes: if only HARQ-NACK feedback information is received, adjusting the contention window size according to the HARQ-NACK feedback information received within the second reference duration.

In this embodiment, when higher-layer signaling or when the sidelink control information (SCI) disables Sidelink Hybrid Automatic Repeat reQuest (HARQ) feedback, the receiving terminal will not transmit Sidelink HARQ feedback for the received Physical Sidelink Share Channel (PSSCH); or, when higher-layer signaling configures Sidelink HARQ feedback as NACK only, the receiving terminal will only feedback Sidelink HARQ-NACK when the received PSSCH is not correctly decoded.

When the communication device executing the processing method of the embodiment of the present application is ready to send at least one of the Physical Sidelink Control Channel (PSCCH) and/or PSSCH, Physical Sidelink Feadback Channel (PSFCH), Sidelink-Synchronization Signal/Physical Sidelink Broadcast Channel (S-SS/PSBCH), the communication device needs to perform Type 1 channel access. First, the communication device senses the channel and waits until a certain frequency channel is idle for at least a period of time called a defer duration, which is generally composed of a 16 μs plus several 9 μs time slots. The length of the defer duration depends on the channel access priority class, and each priority class corresponds to a specific parameter, which is used to determine the defer duration.

When the communication device performs Type 1 channel access, the relevant parameters are shown in Table 1 and Table 2:

TABLE 1
Channel Access Priority Class (CAPC)

| Channel | | | | | |
|---|---|---|---|---|---|
| Access | | | | | |
| Priority | | | | | |
| Class (p) | mₚ | CW_{min, p} | CW_{max, p} | T_{mcot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

In Table 1, p is the channel access priority class; CAPC for DL is the channel access priority class for downlink (DL); mₚ is the m parameter value in the defer duration Td=16 μs+m*9 μs for channel access priority class p; cw_{min,p} is the minimum contention window size for channel access priority class p; cw_{max,p} is the maximum contention window size for channel access priority class p; T_{mcot, p} is the maximum time that channel access priority class p can occupy the frequency band after completing an LBT; allowed cwₚ sizes are the allowed contention window sizes for channel access priority class p.

TABLE 2
Channel Access Priority Class (CAPC)

| Channel | | | | | |
|---|---|---|---|---|---|
| Access | | | | | |
| Priority | | | | | |
| Class (p) | mₚ | CW_{min, p} | CW_{max, p} | T_{ulmcot, p} | allowedCWₚsizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

In Table 2, p is the channel access priority class; CAPC for UL is the channel access priority class for uplink (UL); mₚ is the m parameter value in the defer duration Td=16 μs+m*9 μs for channel access priority class p; cw_{min,p} is the minimum contention window size for channel access priority class p; cw_{max, p} is the maximum contention window size for channel access priority class p; T_{ulm cot, p} is the maximum time that channel access priority class p can occupy the frequency band after completing an LBT; allowed cwₚsizes are the allowed contention window sizes for channel access priority class p.

The content at the bottom of Table 2 is: Note 1: For p=3,4, T_{ulm cot, p}=10 ms if the higher layer parameter absence OfAnyOtherTechnology-r14 or absenceOfAnyOtherTechnology-r16 is provided, otherwise, T_{ulm cot, p}=6 ms

Note 2: When T_{ulm cot, p}=6 ms, it may be increased to 8 ms by inserting one or more gaps. The minimum duration of a gap shall be 100 μs. The maximum duration before including any such gap shall be 6 ms.

In some embodiments, the communication device needs to perform Type 1 channel access. The communication device senses the channel and waits until a certain frequency channel is idle for at least a period of time called a defer duration. This defer duration generally consists of a 16 μs plus several 9 μs time slots. The length of the defer duration depends on channel access priority class. Refer to Table 1 and Table 2 above. If the received energy is lower than the threshold for at least 4 μs in each 9 μs time slot, it means that the channel is available, that is, the channel is idle.

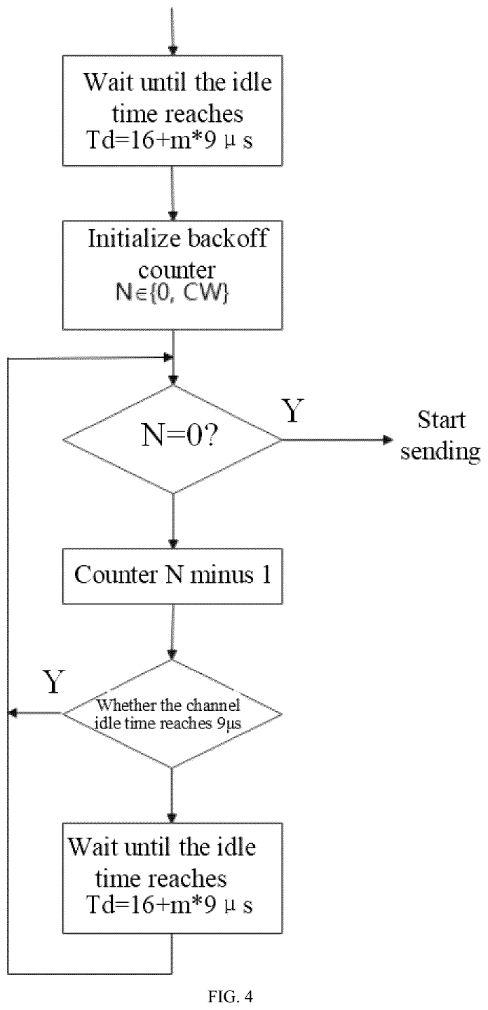

Once the channel is confirmed to be idle within the defer duration, the communication device starts the random backoff mechanism. Referring to FIG. 4, the random backoff process first uses a random number to initialize the backoff counter in the contention window (CW). The random number N comes from the uniform distribution [0, CW], and the multiples of 9 μs represent the duration that the transmission channel must remain idle. If the channel is detected to be idle (i.e., the channel is available) in each 9 μs time slot, the backoff counter is reduced by 1; conversely, whenever the channel is detected to be busy, the backoff counter remains unchanged until the channel idle time reaches the defer duration, where the size of the defer duration is Td=16+m*9 μs. Once the backoff counter returns to zero, the random backoff process is completed. At this time, the communication device has obtained the channel and can use the channel for transmission until the maximum channel occupancy time corresponding to the priority class is reached.

Please referring to the above Table 1 and Table 2, the random backoff mechanism defines four different channel access priority classes. Each channel access priority class has a separate contention window, and the maximum and minimum values of the contention window size are different. Different channel access priority classes are configured for each logical channel. Similarly, different defer durations are used for different channel access priority classes.

If the communication device uses a Type 1 channel access process associated with a channel access priority class p for transmission, the communication device will maintain the contention window size before determining whether the backoff counter is reset to zero, and apply the processing method in the embodiment of the present application to adjust the contention window size for these transmissions. In some feasible embodiments, the contention window size is determined based on the channel state within the first reference duration and/or the feedback information received within the second reference duration.

In an embodiment of the present application, in the case of no HARQ feedback of the physical sidelink shared channel or in the case of only NACK feedback of the physical sidelink shared channel or in the case of a non-control/data channel, after the random backoff mechanism is started, the contention window size is determined according to the channel state within the first reference duration and/or the feedback information received within the second reference duration, and the contention window size is adjusted according to the channel occupancy and information transmission conditions, so as to achieve adaptive adjustment of the contention window size in the random backoff mechanism and avoid communication conflicts between multiple communication devices.

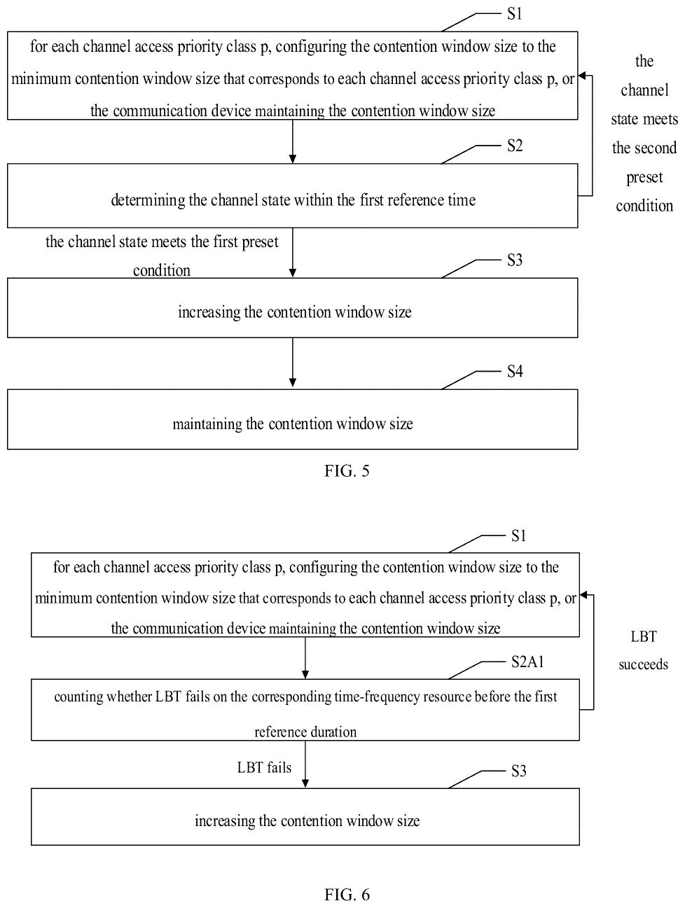

Referring to the above explanations and descriptions of the random backoff mechanism, in other embodiments of the processing method of the present application, when the sidelink control information and/or the high-layer signaling disables the Sidelink HARQ feedback, the receiving terminal does not transmit Sidelink HARQ feedback for the received PSSCH. Referring to FIG. 5, the processing method includes:

Step S1, for each channel access priority class p, configuring the contention window size to the minimum contention window size that corresponds to each channel access priority class p, or the communication device maintaining the contention window size.

Exemplarily, the processing method of the embodiment of the present application can be applied to a communication device. Optionally, the communication device to which the processing method of the present application is applied can be used as a transmitting terminal in inter-device communication to communicate with a receiving terminal.

Exemplarily, if the communication device uses a Type 1 channel access process associated with a channel access priority class p for transmission, before the communication device performs channel access, the contention window size is set to a minimum contention window size adapted to the channel access priority class p.

Exemplarily, the step of configuring the contention window size to the minimum contention window size adapted to the channel access priority class includes: configuring the contention window size to the minimum contention window size of each channel access priority class.

Exemplarily, the step of configuring the contention window size to the minimum contention window size adapted to the channel access priority class includes: configuring the contention window size to the minimum contention window size of the random channel access priority class.

Exemplarily, the step of configuring the contention window size to the minimum contention window size adapted to the channel access priority class includes: configuring the contention window size to the contention window size determined by the channel access priority class of the communication device.

Exemplarily, the step of configuring the contention window size to the minimum contention window size adapted to the channel access priority class includes: configuring the contention window size to the contention window size determined by the channel access priority class of the receiving terminal.

Exemplarily, the step of configuring the contention window size to the minimum contention window size adapted to the channel access priority class includes: if the number of receiving terminals is greater than 1, configuring the contention window size to the contention window size determined by the minimum channel access priority class of the receiving terminal.

Exemplarily, the step of configuring the contention window size to the minimum contention window size adapted to the channel access priority class includes: if the number of receiving terminals is greater than 1, configuring the contention window size to the contention window size determined by the maximum channel access priority class of the receiving terminal.

Exemplarily, the step of configuring the contention window size to the minimum contention window size adapted to the channel access priority class includes: if the number of receiving terminals is greater than 1, configuring the contention window size to the contention window size determined by the random channel access priority class of the receiving terminal.

Exemplarily, the step of configuring the contention window size to the minimum contention window size adapted to the channel access priority class includes: configuring the contention window size to the contention window size determined by the channel access priority class corresponding to the per-packet priority (PPP, ProSe per-packet priority) of the near field communication, where the per-packet priority of the near field communication is provided by the upper layer to the physical layer. There is a corresponding relationship between the channel access priority class and the per-packet priority of the near field communication, and such a corresponding relationship can be preset.

Step S2, determining the channel state within the first reference duration, if the channel status meets the first preset condition, executing step S3; if the channel state meets the second preset condition, executing step S1.

In some embodiments, the channel state includes LBT success and LBT failure, the first preset condition is LBT failure, and the second preset condition is LBT success, and as shown in FIG. 6, step S2 includes:

Step S2A1, counting whether LBT fails on the corresponding time-frequency resource before the first reference duration, if LBT fails, executing step S3; if LBT succeeds, executing step S1; optionally, the time-frequency resource can be used to transmit at least one of the PSCCH, PSSCH, PSFCH and S-SS/PSBCH.

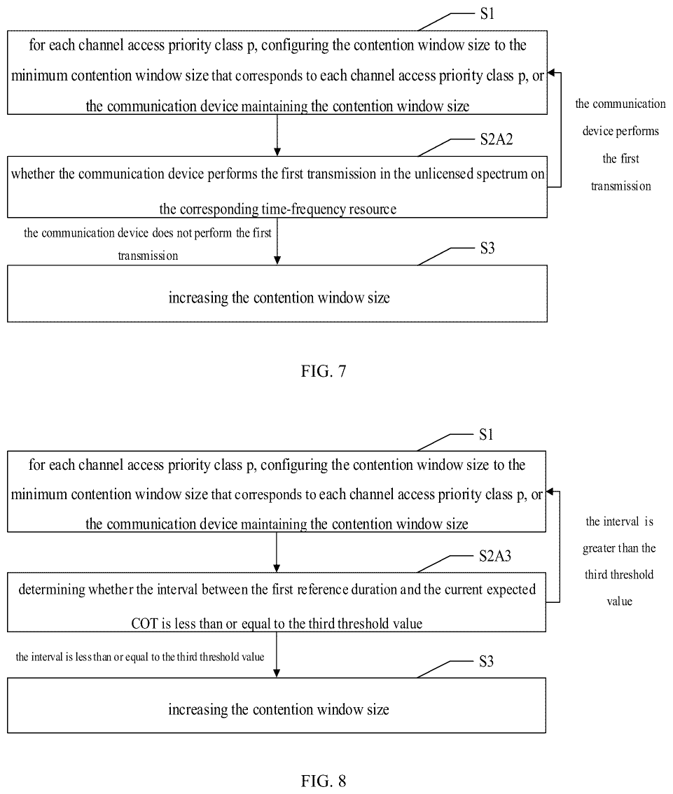

In some embodiments, the channel state also includes the communication device performing the first transmission and/or non-first transmission in the unlicensed spectrum, the first preset condition is that the communication device performs the non-first transmission in the unlicensed spectrum, and the second preset condition is that the communication device performs the first transmission in the unlicensed spectrum, and as shown in FIG. 7, step S2 also includes:

Step S2A2, whether the communication device performs the first transmission in the unlicensed spectrum on the corresponding time-frequency resource. If the communication device does not perform the first transmission in the unlicensed spectrum, execute step S3; if the communication device performs the first transmission in the unlicensed spectrum, execute step S1; optionally, the time-frequency resource can be used to transmit at least one of the PSCCH, PSSCH, PSFCH and S-SS/PSBCH. In this way, when performing the first transmission in the unlicensed spectrum, there is no prior information on the channel state, and step S1 can be directly executed to improve communication efficiency.

In some embodiments, the channel state also includes that the interval between the first reference duration and the current expected COT is greater than the third threshold value and less than or equal to the third threshold value, the first preset condition is that the interval between the first reference duration and the current expected COT is less than or equal to the third threshold value, and the second preset condition is that the interval between the first reference duration and the current expected COT is greater than the third threshold value, and as shown in FIG. 8, step S2 also includes:

Step S2A3, if the interval between the first reference duration and the current expected COT is less than or equal to the third threshold value, then execute step S3; if the interval between the first reference duration and the current expected COT is greater than the third threshold value, then execute step S1.

That is, if the interval between the first reference duration and the currently expected COT is greater than the third threshold value, the contention window size is kept unchanged, or the contention window size is set to the minimum contention window size adapted to the channel access priority class; if the interval between the first reference duration and the currently expected COT is less than or equal to the third threshold value, the contention window size is adjusted according to the channel state. In this way, time domain restrictions are introduced to ensure that the interval between two adjacent COTs is not too long, and the channel state information is available, so as to avoid adjusting the contention window size based on unavailable channel state information, thereby avoiding communication conflicts.

Exemplarily, if the most recent COT occurs before Tw of the currently expected COT, step S1 is executed; otherwise, step S2A1 or step S2A2 is executed. Optionally, Tw is a positive integer, and its unit is milliseconds or slots. For example, the value of Tw can be 20, 40, 60, etc. Tw can be equal to the third threshold value. That is, if the interval between the first reference duration and the currently expected COT is greater than the third threshold value, step S1 is executed; if the interval between the first reference duration and the currently expected COT is less than or equal to the third threshold value, step S2A1 or step S2A2 is executed.

Exemplarily, if the COT of the most recent associated contention window size update is before the Tw of the current expected COT, step S1 is executed; otherwise, step S2A1 or step S2A2 is executed. In an embodiment, Tw is a positive integer, and its unit is milliseconds or time slots. For example, the value of Tw can be 20, 40, 60, etc. Tw can be equal to the third threshold value, and the associated contention window is the contention window of the last successful COT. That is, if the interval between the COT of the most recent associated contention window size update and the current expected COT is greater than the third threshold value, step S1 is executed; if the interval between the COT of the most recent associated contention window size update and the current expected COT is less than or equal to the third threshold value, step S2A1 or step S2A2 is executed.

In an embodiment, the first reference duration is determined by the COT position where the most recent transmission is located;
Or, the first reference duration is determined by at least one candidate position of the first transmission within the COT where the most recent transmission is located;
Or, the first reference duration is determined by the N sensing slots corresponding to the contention window associated with the COT where the most recent transmission is located;
Or, the first reference duration is determined by the COT position associated with the most recent contention window size update.

Or, the first reference duration is determined by the COT position where the most recent transmission with HARQ feedback enabled.

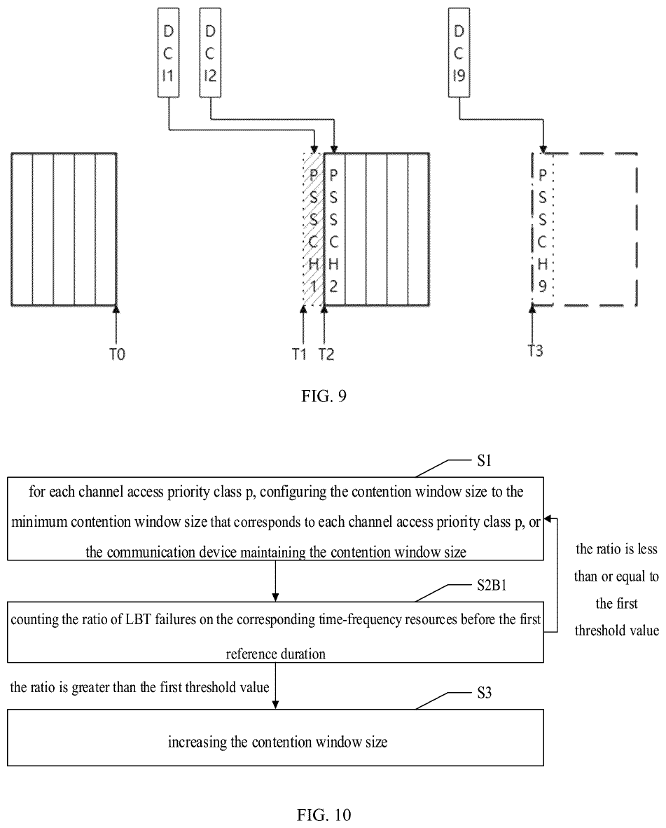

Exemplarily, the first reference duration is determined by the COT position of the most recent transmission. For example, referring to FIG. 9, when the communication device is preparing to transmit PSSCH9, the communication device performs type 1 channel access. When the communication device determines the contention window size, the first reference duration is determined by the COT position of the most recent transmission. For example, the base station indicates that PSSCH1 is transmitted at time T1, and the communication device performs type 1 channel access before time T1. The communication device fails in LBT at time T1 and cannot transmit. At this time, the first reference duration is time T1. The rectangular box represents a COT.

Exemplarily, the first reference duration is the COT starting position that the communication device was most recently scheduled and/or initiated by itself.

Exemplarily, if the base station operates in mode 1, that is, the base station instructs the communication device to start transmission at time T1, then time T1 is the first reference duration.

Exemplarily, the first reference duration is specified by the base station.

Exemplarily, if the base station operates in mode 2, that is, the communication device determines that the position where the initial transmission starts is T1 according to the perception and selection process, then time T1 is the first reference duration.

Exemplarily, the first reference duration is determined autonomously by the communication device.

Exemplarily, when at least one of the PSCCH and/or PSSCH, PSFCH, and S-SS/PSBCH is transmitted within the COT used to determine the first reference duration, the contention window size is updated when the channel access procedure is used.

Exemplarily, the COT used to determine the first reference duration contains a HARQ-enabled PSSCH transmission; that is, the PSSCH transmitted in the COT has an associated HARQ feedback; or the PSCCH of the scheduled PSSCH transmitted in the COT indicates HARQ feedback enablement.

Step S3, increasing the contention window size.

In an embodiment, referring to Tables 1 and 2 above, in step S3, adjust the contention window size CWp to the next larger value until CWmax is reached; that is, configuring the contention window size to the next larger value, for example, increase the contention window size from 3 to 7. The next one refers to the number with the larger sequence number in two adjacent numbers in a group of numbers. When the selected number is the number with the largest sequence number in a group of numbers, the number with the larger sequence number is no longer selected, and the number with the largest sequence number is always selected.

Step S4, maintaining the contention window size.

In an embodiment, in step S4, for each channel access priority class p, the value of the contention window size CWp is maintained; step S1 or step S2 is executed. That is, the contention window size is maintained, and step S1 or step S2 is executed.

In some embodiments, the contention window size is determined according to steps S1 to S4 described above, and the corresponding parameters are applied to the channel access procedure.

In an embodiment, the above-mentioned steps S1, S2, S3 and S4 can be arranged and combined in sequence. For example, the terminal executes step S2 after executing step S1. According to the judgment condition of step S2, if the condition is met, it returns to step S1 and determines the contention window size, and applies the corresponding parameters to the channel access procedure; if the condition is not met, it executes step S3 and step S4. After executing step S4, the contention window size is determined, and the corresponding parameters are applied to the channel access procedure.

In an embodiment, each of the above steps S1, S2, S3 and S4 can be executed separately without relying on the previous steps. For example, after executing step S1, the terminal determines the contention window size and applies the corresponding parameters to the channel access procedure.

In some achievable embodiments, the channel state includes that the ratio of LBT failures within the first reference duration is greater than the first threshold value and less than or equal to the first threshold value, the first preset condition is that the ratio of LBT failures within the first reference duration is greater than the first threshold value, and the second preset condition is that the ratio of LBT failures within the first reference duration is less than or equal to the first threshold value, and as shown in FIG. 10, step S2 includes:

Step S2B1, counting the ratio of LBT failures on the corresponding time-frequency resources before the first reference duration, if the ratio of LBT failures is greater than the first threshold value, executing step S3; if the ratio of LBT failures is less than or equal to the first threshold value, executing step S1. In an embodiment, the time-frequency resources can be used to transmit at least one of the PSCCH, the PSSCH, the PSFCH and the S-SS/PSBCH.

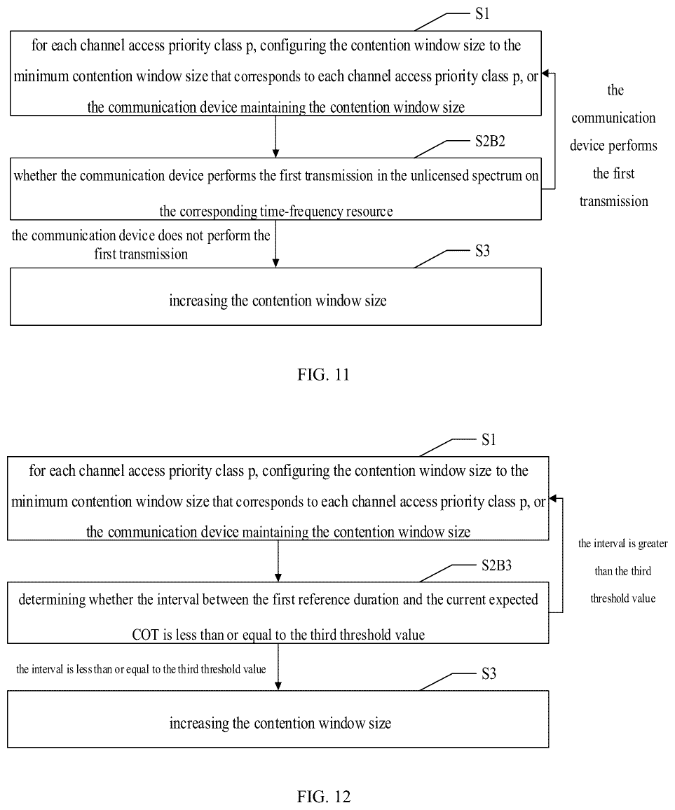

In some embodiments, the channel state includes the communication device performing the first transmission and the non-first transmission in the unlicensed spectrum, the first preset condition is that the communication device performs the non-first transmission in the unlicensed spectrum, and the second preset condition is that the communication device performs the first transmission in the unlicensed spectrum, and as shown in FIG. 11, step S2 includes:

Step S2B2, whether the communication device performs the first transmission in the unlicensed spectrum on the corresponding time-frequency resource. If the communication device does not perform the first transmission in the unlicensed spectrum, execute step S3; if the communication device performs the first transmission in the unlicensed spectrum, execute step S1; optionally, the time-frequency resource can be used to transmit at least one of the PSCCH, PSSCH, PSFCH and S-SS/PSBCH. In this way, when performing the first transmission in the unlicensed spectrum, there is no prior information on the channel state, and step S1 can be directly executed to improve communication efficiency.

In some embodiments, the channel state includes that the interval between the first reference duration and the current expected COT is greater than the third threshold value and less than or equal to the third threshold value, the first preset condition is that the interval between the first reference duration and the current expected COT is less than or equal to the third threshold value, and the second preset condition is that the interval between the first reference duration and the current expected COT is greater than the third threshold value, and as shown in FIG. 12, step S2 includes:

Step S2B3, if the interval between the first reference duration and the current expected COT is less than or equal to the third threshold value, then executing step S3; if the interval between the first reference duration and the current expected COT is greater than the third threshold value, then executing step S1.

That is, if the interval between the first reference duration and the currently expected COT is greater than the third threshold value, the contention window size is kept unchanged, or the contention window size is set to the minimum contention window size adapted to the channel access priority class; if the interval between the first reference duration and the currently expected COT is less than or equal to the third threshold value, the contention window size is adjusted according to the channel state. In this way, time domain restrictions are introduced to ensure that the interval between two adjacent COTs is not too long, and the channel state information is available, so as to avoid adjusting the contention window size based on unavailable channel state information, thereby avoiding communication conflicts.

Exemplarily, if the most recent COT occurs before Tw of the currently expected COT, step S1 is executed; otherwise, step S2B1 or step S2B2 is executed. Optionally, Tw is a positive integer, and its unit is milliseconds or slots. For example, the value of Tw can be 20, 40, 60, etc. Tw can be equal to the third threshold value. That is, if the interval between the first reference duration and the currently expected COT is greater than the third threshold value, step S1 is executed; if the interval between the first reference duration and the currently expected COT is less than or equal to the third threshold value, step S2B1 or step S2B2 is executed.

Exemplarily, if the COT of the most recent associated contention window size update is before the Tw of the current expected COT, then step S1 is executed; otherwise, step S2B1 or step S2B2 is executed. Optionally, the Tw is a positive integer, and its unit is milliseconds or time slots. For example, the value of Tw can be 20, 40, 60, etc. Tw can be equal to the third threshold value, and the associated contention window is the contention window of the last successful COT. That is, if the interval between the COT of the most recent associated contention window size update and the current expected COT is greater than the third threshold value, then step S1 is executed; if the interval between the COT of the most recent associated contention window size update and the current expected COT is less than or equal to the third threshold value, then step S2B1 or step S2B2 is executed.

In an embodiment, the first reference duration is determined by the COT position where the most recent transmission is located;
Or, the first reference duration is determined by at least one candidate position of the first transmission within the COT where the most recent transmission is located;
Or, the first reference duration is determined by the N sensing slots corresponding to the contention window associated with the COT where the most recent transmission is located;
Or, the first reference duration is determined by the COT position associated with the most recent contention window size update.

Or, the first reference duration is determined by the COT position where the most recent transmission with HARQ feedback enabled.

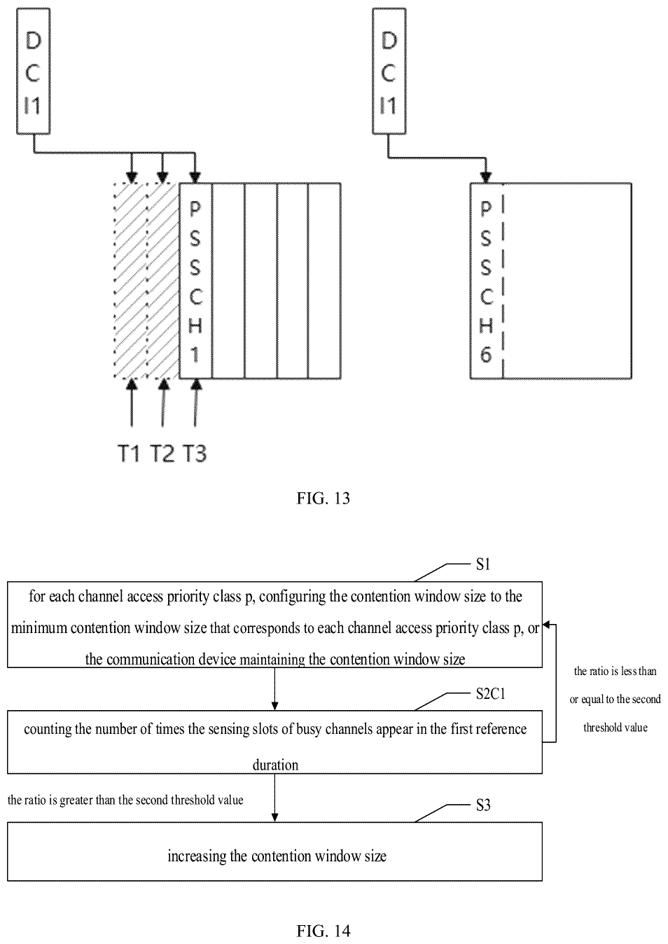

Exemplarily, the first reference duration is determined by the COT position of the most recent transmission. For example, referring to FIG. 13, when the communication device is preparing to transmit PSSCH9, the communication device performs type 1 channel access. When the communication device determines the contention window size, the first reference duration is determined by the COT position of the most recent transmission. For example, the base station indicates that PSSCH1 is transmitted at time T1, and the communication device performs type 1 channel access before time T1. The communication device fails LBT at time T1 or the ratio of LBT failures is greater than the first threshold value. The communication device continues to perform LBT, and at time T2, LBT still fails or the ratio of LBT failures is still greater than the first threshold value, and transmission cannot be performed; the communication device continues to perform LBT, and at time T3, LBT succeeds or the ratio of LBT failures is still less than or equal to the first threshold value, and transmission can be performed. At this time, the first reference duration is from time T1 to time T3. Optionally, the rectangular box represents a COT.

Exemplarily, the first reference duration is a plurality of candidate positions starting from the COT that the communication device was last scheduled.

Exemplarily, if the base station operates in mode 1, that is, the base station instructs the communication device to transmit at a plurality of candidate positions, then the plurality of candidate positions are the first reference duration.

Exemplarily, the first reference duration is specified by the base station.

Exemplarily, if the base station operates in mode 2, that is, the communication device determines a plurality of candidate positions for the initial transmission according to the perception and selection process, the plurality of candidate positions are the first reference duration.

Exemplarily, the first reference duration is determined autonomously by the communication device.

Exemplarily, the first threshold value is configured by high-layer signaling.

Exemplarily, the first threshold value is predefined.

Exemplarily, the ratio of LBT failures is determined by the ratio of the number of LBT failures to the number of candidate positions for one transmission.

Exemplarily, when at least one of the PSCCH, PSSCH, PSFCH and S-SS/PSBCH is transmitted in the COT used to determine the first reference duration, the contention window size is updated when the channel access procedure is used.

Exemplarily, the COT used to determine the first reference duration includes HARQ-enabled PSSCH transmission; that is, the PSSCH transmitted in the COT has associated HARQ feedback; or the PSCCH of the scheduled PSSCH transmitted in the COT indicates HARQ feedback enablement.

In some feasible embodiments, the channel state includes that the ratio of the sensing slots of busy channels within the first reference duration is greater than the second threshold value and less than or equal to the second threshold value, the first preset condition is that the ratio of the sensing slots of busy channels within the first reference duration is greater than the second threshold value, and the second preset condition is that the ratio of the sensing slots of busy channels within the first reference duration is less than or equal to the second threshold value, and as shown in FIG. 14, step S2 includes:

Step S2C1, counting the number of times the sensing slots of busy channels appear in the first reference duration. If the ratio of sensing slots of busy channels in the first reference duration is greater than the second threshold value, executing step S3; if the ratio of sensing slots of busy channels in the first reference duration is less than or equal to the second threshold value, executing step S1.

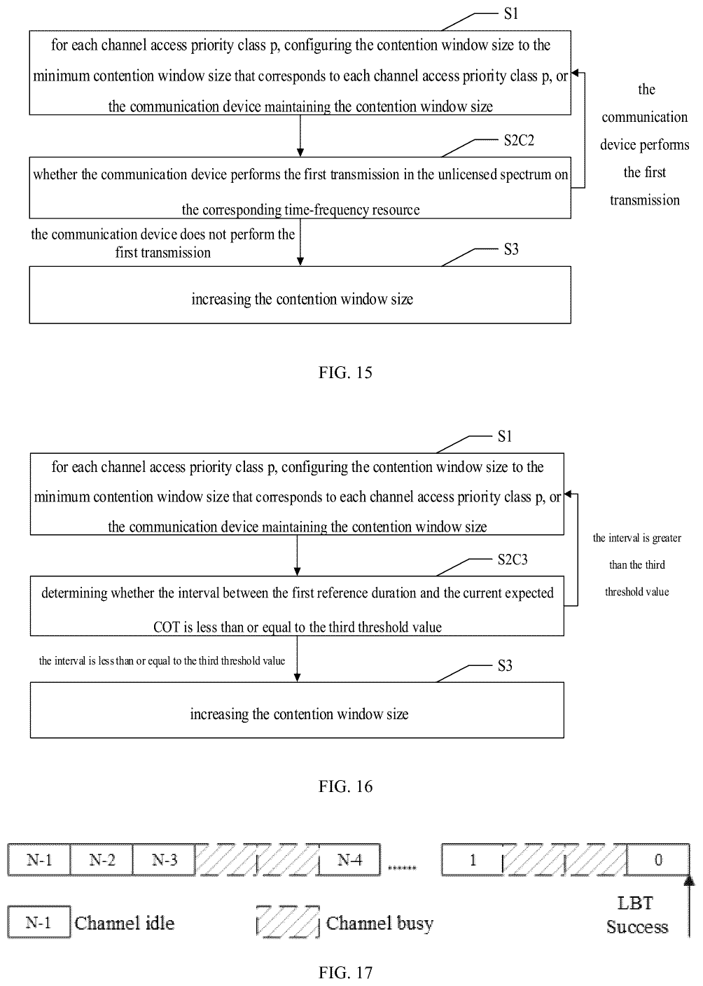

In some embodiments, the channel state includes the communication device performing the first transmission and the non-first transmission in the unlicensed spectrum, the first preset condition is that the communication device performs the non-first transmission in the unlicensed spectrum, and the second preset condition is that the communication device performs the first transmission in the unlicensed spectrum, and as shown in FIG. 15, step S2 includes:

Step S2C2, whether the communication device performs the first transmission in the unlicensed spectrum on the corresponding time-frequency resource. If the communication device does not perform the first transmission in the unlicensed spectrum, executing step S3; if the communication device performs the first transmission in the unlicensed spectrum, executing step S1; optionally, the time-frequency resource can be used to transmit at least one of the PSCCH, PSSCH, PSFCH and S-SS/PSBCH. In this way, when performing the first transmission in the unlicensed spectrum, there is no prior information on the channel state, and step S1 can be directly executed to improve communication efficiency.

In some embodiments, the channel state includes that the interval between the first reference duration and the currently expected COT is greater than a third threshold value and less than or equal to the third threshold value, the first preset condition is that the interval between the first reference duration and the currently expected COT is less than or equal to the third threshold value, and the second preset condition is that the interval between the first reference duration and the currently expected COT is greater than the third threshold value, and as shown in FIG. 16, step S2 includes:

Step S2C3, if the interval between the first reference duration and the currently expected COT is less than or equal to the third threshold value, executing step S3; if the interval between the first reference duration and the currently expected COT is greater than the third threshold value, executing step S1.

That is, if the interval between the first reference duration and the currently expected COT is greater than the third threshold value, the contention window size is kept unchanged, or the contention window size is set to the minimum contention window size adapted to the channel access priority class; if the interval between the first reference duration and the currently expected COT is less than or equal to the third threshold value, the contention window size is adjusted according to the channel state. In this way, time domain restrictions are introduced to ensure that the interval between two adjacent COTs is not too long, and channel state information is available, so as to avoid adjusting the contention window size based on unavailable state information, thereby avoiding communication conflicts.

Exemplarily, if the most recent COT occurs before Tw of the currently expected COT, step S1 is executed; otherwise, step S2C1 or step S2C2 is executed. Optionally, Tw is a positive integer, and its unit is milliseconds or slots. For example, the value of Tw can be 20, 40, 60, etc. Tw can be equal to the third threshold value. That is, if the interval between the first reference duration and the currently expected COT is greater than the third threshold value, step S1 is executed; if the interval between the first reference duration and the currently expected COT is less than or equal to the third threshold value, step S2C1 or step S2C2 is executed.

Exemplarily, if the COT of the most recent associated contention window size update is before the Tw of the current expected COT, then step S1 is executed; otherwise, step S2C1 or step S2C2 is executed. Optionally, the Tw is a positive integer, and its unit is milliseconds or time slots. For example, the value of Tw can be 20, 40, 60, etc. Tw can be equal to the third threshold value, and the associated contention window is the contention window of the last successful COT. That is, if the interval between the COT of the most recent associated contention window size update and the current expected COT is greater than the third threshold value, then step S1 is executed; if the interval between the COT of the most recent associated contention window size update and the current expected COT is less than or equal to the third threshold value, then step S2C1 or step S2C2 is executed.

Optionally, the first reference duration is determined by the COT position where the most recent transmission is located;
Or, the first reference duration is determined by at least one candidate position of the first transmission within the COT where the most recent transmission is located;
Or, the first reference duration is determined by the N sensing slots corresponding to the contention window associated with the COT where the most recent transmission is located;
Or, the first reference duration is determined by the COT position associated with the most recent contention window size update.

Or, the first reference duration is determined by the COT position where the most recent transmission with HARQ feedback enabled.

Exemplarily, the first reference duration is N sensing slots corresponding to the random number N generated by the communication device in the most recent contention window, and the sensing slot is a channel detection unit. Optionally, the number of times of the sensing slot of the busy channels is counted as Y. If the communication device detects that the channel is busy within a 9 μs sensing slot, the number of sensing slots of the busy channels is increased by 1, and the initial value is 0. For example, referring to FIG. 17, N channel idle sensing slots appear one after another, and several sensing slots of the busy channels appear during this period.

In an embodiment, the number of times that the sensing slots of the busy channels is Y, and the ratio of the number of times that the sensing slots of the busy channels to the first reference duration is Y/N.

In an embodiment, the second threshold is configured by high-layer signaling.

In an embodiment, the second threshold is predefined.

Exemplarily, when at least one of the PSCCH, PSSCH, PSFCH and S-SS/PSBCH is transmitted within the COT used to determine the first reference duration, the contention window size is updated when the channel access procedure is used.

Exemplarily, the COT used to determine the first reference duration includes a HARQ-enabled PSSCH transmission; that is, the PSSCH transmitted in the COT has an associated HARQ feedback; or the PSCCH of the scheduled PSSCH transmitted in the COT indicates that HARQ feedback is enabled.

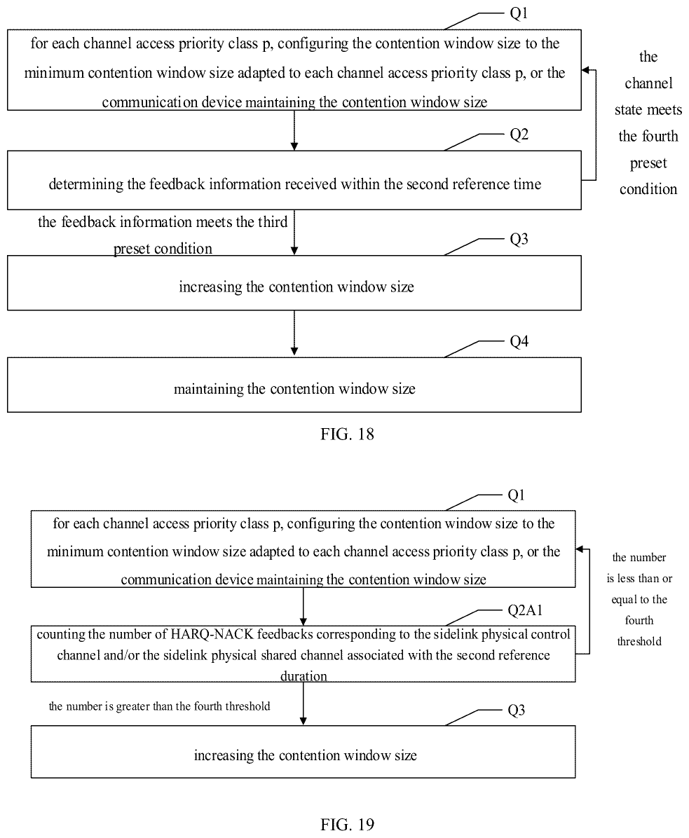

Referring to the above explanations and descriptions of the random backoff mechanism, in some other embodiments of the processing method of the present application, when the sidelink control information and/or high-layer signaling configures the Sidelink HARQ feedback as NACK only, the receiving terminal will only feedback Sidelink HARQ-NACK when the received PSSCH is not correctly decoded. Referring to FIG. 18, the processing method includes:

Step Q1, for each channel access priority class p, configuring the contention window size to the minimum contention window size adapted to each channel access priority class p, or the communication device maintaining the contention window size.

Exemplarily, the processing method of the embodiment of the present application can be applied to a communication device. Optionally, the communication device to which the processing method of the present application is applied can be used as a transmitting terminal in inter-device communication to communicate with a receiving terminal.

Exemplarily, if the communication device uses a type 1 channel access process associated with the channel access priority class p for transmission, before the communication device performs channel access, the contention window size is set to the minimum contention window size adapted to the channel access priority class p.

Exemplarily, the step of configuring the contention window size to the minimum contention window size adapted to the channel access priority class includes: configuring the contention window size to the minimum contention window size of each channel access priority class.

Exemplarily, the step of configuring the contention window size to the minimum contention window size adapted to the channel access priority class includes: configuring the contention window size to the minimum contention window size of the random channel access priority class.

Exemplarily, the step of configuring the contention window size to the minimum contention window size adapted to the channel access priority class includes: configuring the contention window size to the contention window size determined by the channel access priority class of the communication device.

Exemplarily, the step of configuring the contention window size to the minimum contention window size adapted to the channel access priority class includes: configuring the contention window size to the contention window size determined by the channel access priority class of the receiving terminal.

Exemplarily, the step of configuring the contention window size to the minimum contention window size adapted to the channel access priority class includes: if the number of receiving terminals is greater than 1, configuring the contention window size to the contention window size determined by the minimum channel access priority class of the receiving terminal.

Exemplarily, the step of configuring the contention window size to the minimum contention window size adapted to the channel access priority class includes: if the number of receiving terminals is greater than 1, configuring the contention window size to the contention window size determined by the maximum channel access priority class of the receiving terminal.

Exemplarily, the step of configuring the contention window size to the minimum contention window size adapted to the channel access priority class includes: if the number of receiving terminals is greater than 1, configuring the contention window size to the contention window size determined by the random channel access priority class of the receiving terminal.

Exemplarily, the step of configuring the contention window size to the minimum contention window size adapted to the channel access priority class includes: configuring the contention window size to the contention window size determined by the channel access priority class corresponding to the per-packet priority (PPP, ProSe per-packet priority) of the near field communication, where the per-packet priority of the near field communication is provided by the upper layer to the physical layer. There is a corresponding relationship between the channel access priority class and the per-packet priority of the near field communication, and such a corresponding relationship can be preset.

Step Q2, determining the feedback information received within the second reference duration. If the feedback information meets the third preset condition, executing step Q3; if the feedback information meets the fourth preset condition, executing step Q1.

In some embodiments, the feedback information includes the number of NACK feedbacks received by the communication device within the second reference duration, the third preset condition is that the number of NACK feedbacks received within the second reference duration is greater than the fourth threshold value, and the fourth preset condition is that the number of NACK feedbacks received within the second reference duration is less than or equal to the fourth threshold value, and as shown in FIG. 19, step Q2 includes:

Step Q2A1, counting the number of HARQ-NACK feedbacks corresponding to the sidelink physical control channel and/or the sidelink physical shared channel associated with the second reference duration, that is, the number of NACK feedbacks received by the communication device, if the number of NACK feedbacks received by the communication device is greater than the fourth threshold, executing step Q3; if the number of NACK feedbacks received by the communication device is less than or equal to the fourth threshold, executing step Q1;

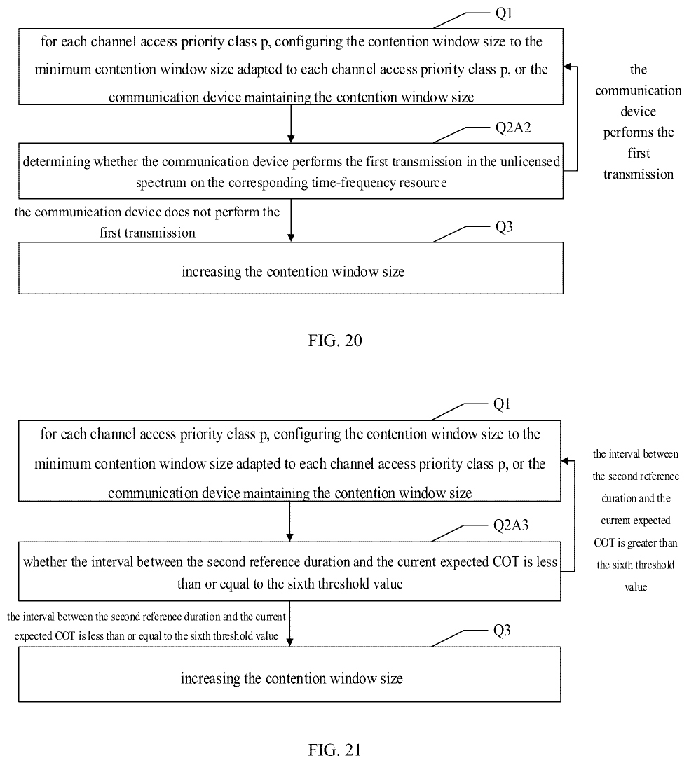

In some embodiments, whether the communication device performs the first transmission or non-first transmission in the unlicensed spectrum on the corresponding time-frequency resource, the third preset condition is that the communication device performs non-first transmission in the unlicensed spectrum, and the fourth preset condition is that the communication device performs the first transmission in the unlicensed spectrum, and as shown in FIG. 20, step Q2 includes:

Step Q2A2, whether the communication device performs the first transmission in the unlicensed spectrum on the corresponding time-frequency resource. If the communication device does not perform the first transmission in the unlicensed spectrum, executing step Q3; if the communication device performs the first transmission in the unlicensed spectrum, executing step Q1; optionally, the time-frequency resource can be used to transmit at least one of the PSCCH, PSSCH, PSFCH and S-SS/PSBCH. In this way, when performing the first transmission in the unlicensed spectrum, there is no prior information on the channel state, and step Q1 can be directly executed to improve communication efficiency.

In some embodiments, it is determined whether the interval between the second reference duration and the current expected COT is greater than the sixth threshold value or less than or equal to the sixth threshold value, the third preset condition is that the interval between the second reference duration and the current expected COT is less than or equal to the sixth threshold value, and the fourth preset condition is that the interval between the second reference duration and the current expected COT is greater than the sixth threshold value, and as shown in FIG. 21, step Q2 includes:

Step Q2A3, if the interval between the second reference duration and the current expected COT is less than or equal to the sixth threshold value, then executing step Q3; if the interval between the second reference duration and the current expected COT is greater than the sixth threshold value, then executing step Q1.

That is, if the interval between the second reference duration and the currently expected COT is greater than the sixth threshold value, the contention window size is kept unchanged, or the contention window size is set to the minimum contention window size adapted to the channel access priority class; if the interval between the first reference duration and the currently expected COT is less than or equal to the sixth threshold value, the contention window size is adjusted according to the feedback information received within the second reference duration. In this way, time domain restrictions are introduced to ensure that the interval between two adjacent COTs is not too long, and the channel state information is available, so as to avoid adjusting the contention window size based on unavailable channel state information, thereby avoiding communication conflicts.

Exemplarily, if the most recent COT occurs before Tw of the current expected COT, step Q1 is executed; otherwise, step Q2A1 or step Q2A2 is executed. Optionally, Tw is a positive integer, and its unit is milliseconds or slots. For example, the value of Tw can be 20, 40, 60, etc., and Tw can be equal to the sixth threshold value. That is, if the interval between the second reference duration and the current expected COT is greater than the sixth threshold value, step Q1 is executed; if the interval between the second reference duration and the current expected COT is less than or equal to the sixth threshold value, step Q2A1 or step Q2A2 is executed.

Exemplarily, if the COT of the most recent associated contention window size update is before the Tw of the current expected COT, step Q1 is executed; otherwise, step Q2A1 or step Q2A2 is executed. Optionally, Tw is a positive integer, and its unit is milliseconds or time slots. For example, the value of Tw can be 20, 40, 60, etc. Tw can be equal to the sixth threshold value, and the associated contention window is the contention window of the last successful COT. That is, if the interval between the COT of the most recent associated contention window size update and the current expected COT is greater than the sixth threshold value, step Q1 is executed; if the interval between the COT of the most recent associated contention window size update and the current expected COT is less than or equal to the third threshold value, step Q2A1 or step Q2A2 is executed.

In an embodiment, the second reference duration is determined by the COT position where the most recent transmission is located;
Or, the second reference duration is determined by the COT position associated with the most recent contention window size update;
Or, the second reference duration is determined by the COT position where the most recent transmission with HARQ feedback enabled.

Exemplarily, the second reference duration is the first complete time slot used to transmit the sidelink physical control channel and/or the sidelink physical shared channel in the COT most recently started by the communication device.

Exemplarily, the second reference duration is the first time slot used to transmit the sidelink physical control channel and/or the sidelink physical shared channel in the COT most recently started by the communication device.

Exemplarily, the fourth threshold is configured by high-layer signaling.

Exemplarily, the fourth threshold is predefined.

Exemplarily, when at least one of the PSCCH and/or PSSCH, PSFCH, and S-SS/PSBCH is transmitted within the COT used to determine the first reference duration, the contention window size is updated when the channel access procedure is used.

Exemplarily, the COT used to determine the first reference duration includes a HARQ-enabled PSSCH transmission; that is, the PSSCH transmitted within the COT has an associated HARQ feedback; or the PSCCH of the scheduled PSSCH transmitted within the COT indicates HARQ feedback enablement.

Step Q3, increasing the contention window size.

Optionally, referring to Table 1 and Table 2 above, in step Q3, the contention window size CWp is adjusted to the next larger value until CWmax is reached; that is, the contention window size is set to the next larger value, for example, the contention window size is increased from 3 to 7. The next one refers to the number with the larger sequence number among two adjacent numbers in a group of numbers. When the selected number is the number with the largest sequence number in a group of numbers, the number with the larger sequence number is no longer selected, and the number with the largest sequence number is always selected.

Step Q4, maintaining the contention window size.

In an embodiment, in step Q4, for each channel access priority class p, keep the value of the contention window size CWp; execute step Q1 or execute step Q2. That is, keep the contention window size, execute step Q1 or step Q2.

In some embodiments, the contention window size is determined according to the steps Q1 to Q4 described above, and the corresponding parameters are applied to the channel access procedure.

In an embodiment, the above steps Q1, Q2, Q3 and Q4 can be arranged and combined in sequence, for example, the terminal executes step Q2 after executing step Q1, and according to the judgment condition of step Q2, if the condition is met, it returns to step Q1 and determines the contention window size, and applies the corresponding parameters to the channel access procedure; if the condition is not met, it executes step Q3, and executes step Q4, and after executing step Q4, the contention window size is determined, and the corresponding parameters are applied to the channel access procedure.

In an embodiment, each of the above steps Q1, Q2, Q3 and Q4 can be executed separately, independent of the previous steps. For example, after executing step Q1, the terminal determines the contention window size and applies the corresponding parameters to the channel access procedure.

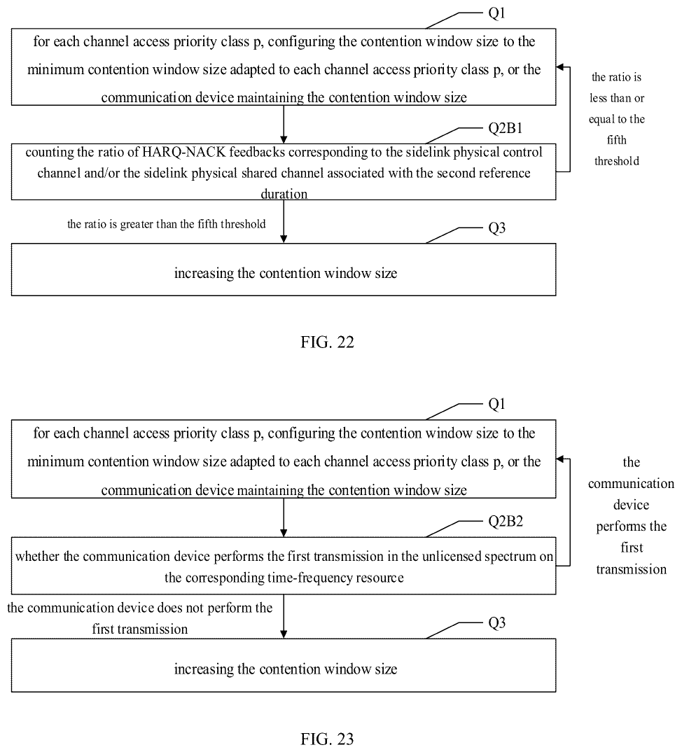

In some feasible embodiments, the feedback information includes a ratio of NACK feedback received within a second reference duration, the third preset condition is that the ratio of NACK feedback received within the second reference duration is greater than a fifth threshold value, the fourth preset condition is that the ratio of NACK feedback received within the second reference duration is less than or equal to the fifth threshold value, and as shown in FIG. 22, step Q2 includes:

Step Q2B1, counting the ratio of HARQ-NACK feedback corresponding to the sidelink physical control channel and/or the sidelink physical shared channel associated with the second reference duration, that is, the ratio of NACK feedback received by the communication device, if the ratio of NACK feedback received by the communication device is greater than the fifth threshold, executing step Q3; if the ratio of NACK feedback received by the communication device is less than or equal to the fifth threshold, executing step Q1.

In some embodiments, determining whether the second reference duration is the first transmission or non-first transmission of the communication device in the unlicensed spectrum, the third preset condition is that the communication device is not transmitting for the first time in the unlicensed spectrum, and the fourth preset condition is that the communication device is transmitting for the first time in the unlicensed spectrum, as shown in FIG. 23, step Q2 includes:

Step Q2B2, before the second reference duration, counting whether the communication device performs the first transmission in the unlicensed spectrum on the corresponding time-frequency resource. If the communication device does not perform the first transmission in the unlicensed spectrum, executing step Q3; if the communication device performs the first transmission in the unlicensed spectrum, executing step Q1. In an embodiment, the time-frequency resource can be used to transmit at least one of the PSCCH, PSSCH, PSFCH and S-SS/PSBCH. In this way, when performing the first transmission in the unlicensed spectrum, there is no prior information on the channel state, and step Q1 can be directly executed to improve communication efficiency.

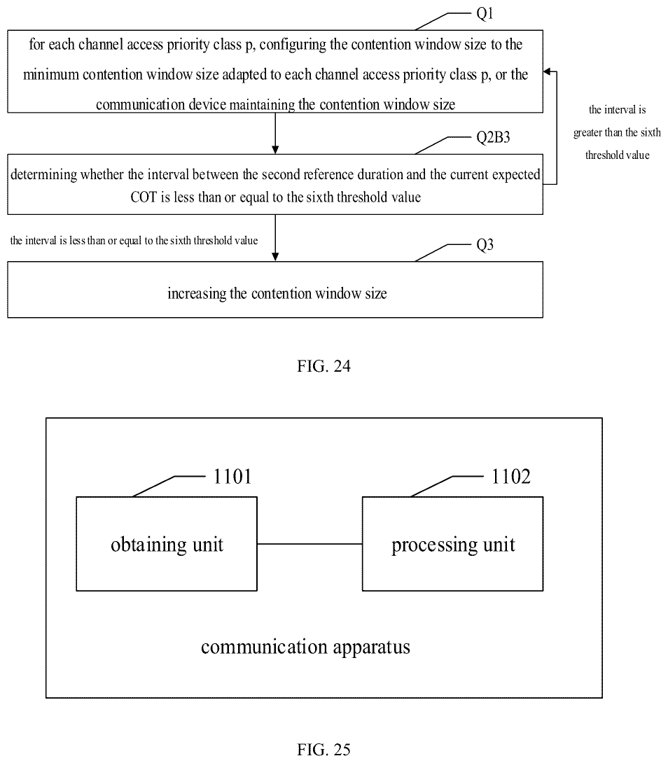

In some embodiments, it is determined whether the interval between the second reference duration and the current expected COT is greater than the sixth threshold value and less than or equal to the sixth threshold value, the third preset condition is that the interval between the second reference duration and the current expected COT is less than or equal to the sixth threshold value, and the fourth preset condition is that the interval between the second reference duration and the current expected COT is greater than the sixth threshold value, and as shown in FIG. 24, step Q2 includes:

Step Q2B3, if the interval between the second reference duration and the current expected COT is less than or equal to the sixth threshold value, then executing step Q3; if the interval between the second reference duration and the current expected COT is greater than the sixth threshold value, then executing step Q1.

That is, if the interval between the second reference duration and the currently expected COT is greater than the sixth threshold value, the contention window size is kept unchanged, or the contention window size is set to the minimum contention window size adapted to the channel access priority class; if the interval between the second reference duration and the currently expected COT is less than or equal to the sixth threshold value, the feedback information received within the second reference duration adjusts the contention window size. In this way, time domain restrictions are introduced to ensure that the interval between two adjacent COTs is not too long, and channel state information is available, so as to avoid adjusting the contention window size based on unavailable channel state information, thereby avoiding communication conflicts.

Exemplarily, if the most recent COT occurs before Tw of the current expected COT, step Q1 is executed; otherwise, step Q2B1 or step Q2B2 is executed. Optionally, Tw is a positive integer, and its unit is milliseconds or slots. For example, the value of Tw can be 20, 40, 60, etc., and Tw can be equal to the sixth threshold value. That is, if the interval between the second reference duration and the current expected COT is greater than the sixth threshold value, step Q1 is executed; if the interval between the second reference duration and the current expected COT is less than or equal to the sixth threshold value, step Q2B1 or step Q2B2 is executed.

Exemplarily, if the COT of the most recent associated contention window size update is before the Tw of the current expected COT, then step Q1 is executed; otherwise, step Q2B1 or step Q2B2 is executed. Optionally, Tw is a positive integer, and its unit is milliseconds or time slots. For example, the value of Tw can be 20, 40, 60, etc. Tw can be equal to the sixth threshold value, and the associated contention window is the contention window of the last successful COT. That is, if the interval between the COT of the most recent associated contention window size update and the current expected COT is greater than the sixth threshold value, then step Q1 is executed; if the interval between the COT of the most recent associated contention window size update and the current expected COT is less than or equal to the sixth threshold value, then step Q2B1 or step Q2B2 is executed.

In an embodiment, the second reference duration is determined by the COT position where the most recent transmission is located;
Or, the second reference duration is determined by the COT position associated with the most recent contention window size update;
Or, the second reference duration is determined by the COT position where the most recent transmission with HARQ feedback enabled.

Exemplarily, the second reference duration is the first complete time slot used to transmit the sidelink physical control channel and/or the sidelink physical shared channel in the COT most recently started by the communication device.

Exemplarily, the second reference duration is the first time slot used to transmit the sidelink physical control channel and/or the sidelink physical shared channel in the COT most recently started by the communication device.

Exemplarily, the fourth threshold is configured by high-layer signaling.

Exemplarily, the fourth threshold is predefined.

Exemplarily, when at least one of the PSCCH, PSSCH, PSFCH and S-SS/PSBCH is transmitted in the COT used to determine the first reference duration, the contention window size is updated when the channel access procedure is used.

Exemplarily, the COT used to determine the first reference duration contains a HARQ-enabled PSSCH transmission; that is, the PSSCH transmitted in the COT has an associated HARQ feedback; or the PSCCH of the scheduled PSSCH transmitted in the COT indicates HARQ feedback enablement.

Step Q3, increasing the contention window size.

In an embodiment, referring to Tables 1 and 2 above, in step Q3, the contention window size CWp is adjusted to the next larger value until CWmax is reached; that is, the contention window size is set to the next larger value, for example, the contention window size is increased from 3 to 7. The next one refers to the number with the larger sequence number among two adjacent numbers in a group of numbers. When the selected number is the number with the largest sequence number in a group of numbers, the number with the larger sequence number is no longer selected, and the number with the largest sequence number is always selected.

Step Q4, maintaining the contention window size.

In an embodiment, in step Q4, for each channel access priority class p, keep the value of the contention window size CWp; execute step Q1 or execute step Q2. That is, keep the contention window size, execute step Q1 or step Q2.

In some embodiments, the contention window size is determined according to the steps Q1 to Q4 described above, and the corresponding parameters are applied to the channel access procedure.

In an embodiment, the above steps Q1, Q2, Q3 and Q4 can be arranged and combined in sequence, for example, the terminal executes step Q2 after executing step Q1, and according to the judgment condition of step Q2, if the condition is met, it returns to step Q1 and determines the contention window size, and applies the corresponding parameters to the channel access procedure; if the condition is not met, it executes step Q3 and executes step Q4, and after executing step Q4, the contention window size is determined, and the corresponding parameters are applied to the channel access procedure.

In an embodiment, each of the above steps Q1, Q2, Q3 and Q4 can be executed separately, independent of the previous steps. For example, after executing step Q1, the terminal determines the contention window size and applies corresponding parameters to a channel access procedure.

Please referring to FIG. 25, which is a schematic structural diagram of a communication apparatus according to an embodiment of the present application. The device can be mounted on a communication device in the above method embodiment, and the communication device can specifically be a mobile terminal. The communication apparatus shown in FIG. 25 can be used to perform some or all of the functions in the method embodiments described in FIGS. 3, 5, 13 and 18 above. The detailed description of each unit is as follows:

The obtaining unit 1101 is configured for obtaining the channel state within the first reference duration and/or the feedback information received within the second reference duration; the processing unit 1102 is configured for determining the contention window size according to the channel state within the first reference duration and/or the feedback information received within the second reference duration.

In an optional implementation, the channel state includes at least one of the following: LBT success, LBT failure, a ratio of LBT failures, and a ratio of sensing slots of busy channels; and
the feedback information includes at least one of the following: a number of NACK feedbacks, a ratio of NACK feedbacks, a number of ACK feedbacks, and a ratio of ACK feedbacks.

In an optional implementation, the processing unit 1102 is further configured for:
in response to that there is no HARQ feedback for a physical sidelink shared channel, adjusting or maintaining the contention window size according to the channel state within the first reference duration; and
in response to that only HARQ-NACK feedback information is received, adjusting the contention window size according to the HARQ-NACK feedback information received within the second reference duration.

In an optional implementation, the processing unit 1102 is further configured for:
in response to that LBT fails within the first reference duration, increasing the contention window size;
in response to that the ratio of LBT failures within the first reference duration is greater than a first threshold value, increasing the contention window size;
in response to that the ratio of the sensing slots of busy channels within the first reference duration is greater than a second threshold value, increasing the contention window size;
in response to that LBT succeeds within the first reference duration, maintaining the contention window size, or configuring the contention window size to a minimum contention window size adapted to a channel access priority class;
in response to that the ratio of LBT failures within the first reference duration is less than or equal to the first threshold value, maintaining the contention window size, or configuring the contention window size to the minimum contention window size adapted to the channel access priority class;
in response to that the ratio of the sensing slots of the busy channels within the first reference duration is less than or equal to the second threshold value, maintaining the contention window size, or configuring the contention window size to the minimum contention window size adapted to the channel access priority class;
in response to that the number of NACK feedbacks received within the second reference duration is greater than a fourth threshold value, increasing the contention window size;
in response to that the number of NACK feedbacks received within the second reference duration is less than or equal to the fourth threshold value, maintaining the contention window size, or configuring the contention window size to the minimum contention window size adapted to the channel access priority class;
in response to that the ratio of NACK feedbacks received within the second reference duration is greater than a fifth threshold value, increasing the contention window size; and
in response to that the ratio of NACK feedbacks received within the second reference duration is less than or equal to the fifth threshold value, maintaining the contention window size, or configuring the contention window size to the minimum contention window size adapted to the channel access priority class.

In an optional implementation, the processing unit 1102 is further configured for:
configuring the contention window size to the minimum contention window size of each channel access priority class;
configuring the contention window size to the minimum contention window size of a random channel access priority class;
configuring the contention window size to the contention window size determined by a channel access priority class of a communication device;
configuring the contention window size to the contention window size determined by a channel access priority class of a receiving terminal;
configuring the contention window size to the contention window size determined by a minimum channel access priority class of the receiving terminal;
configuring the contention window size to the contention window size determined by a maximum channel access priority class of the receiving terminal;
configuring the contention window size to the contention window size determined by a random channel access priority class of the receiving terminal; and
configuring the contention window size to the contention window size determined by a channel access priority class corresponding to per-packet priority of near field communication.

In an optional implementation, the processing unit 1102 is further configured for:
in response to that an interval between the first reference duration and the currently expected COT is greater than a third threshold value, maintaining the contention window size, or configuring the contention window size to the minimum contention window size adapted to the channel access priority class;
in response to that the interval between the first reference duration and the currently expected COT is less than or equal to the third threshold value, adjusting the contention window size according to the channel state;
in response to that an interval between the second reference duration and the currently expected COT is greater than a sixth threshold value, maintaining the contention window size, or configuring the contention window size to the minimum contention window size adapted to the channel access priority class;
in response to that the interval between the second reference duration and the currently expected COT is less than or equal to the sixth threshold value, adjusting the contention window size according to the received feedback information; and
in response to that a communication device performs a first transmission in an unlicensed spectrum, maintaining the contention window size, or configuring the contention window size to the minimum contention window size adapted to the channel access priority class.

In an optional implementation, a way for determining the first reference duration includes at least one of the following:
determining the first reference duration by COT position where the most recent transmission is located;
determining the first reference duration by at least one candidate position of the first transmission within the COT where the most recent transmission is located;
determining the first reference duration by N sensing slots corresponding to the contention window associated with the COT where the most recent transmission is located;
determining the first reference duration by the COT position associated with the most recent contention window size update; and
determining the first reference duration by the COT position where the most recent transmission with HARQ-ACK feedback enabled;
a way for determining the second reference duration includes at least one of the following:
determining the second reference duration by COT position where the most recent transmission is located;
determining the second reference duration by the COT position associated with the most recent contention window size update; and
determining the second reference duration by the COT position where the most recent transmission with HARQ-ACK feedback enabled.

According to an embodiment of the present application, some steps involved in the image processing method shown in FIG. 3, FIG. 5, FIG. 13 and FIG. 18 can be performed by various modules in the communication apparatus shown in FIG. 25. The various units in the communication apparatus shown in FIG. 25 can be respectively or completely combined into one or several other modules to form, or one (some) of the modules can be further divided into multiple functionally smaller units to form, which can achieve the same operation without affecting the realization of the technical effect of the embodiment of the present application. The above units are divided based on logical functions. In practical applications, the function of one module can also be realized by multiple modules, or the functions of multiple modules can be realized by one module. In other embodiments of the present application, the processing device can also include other modules. In practical applications, these functions can also be implemented with the assistance of other modules, and can be implemented by multiple modules in collaboration.

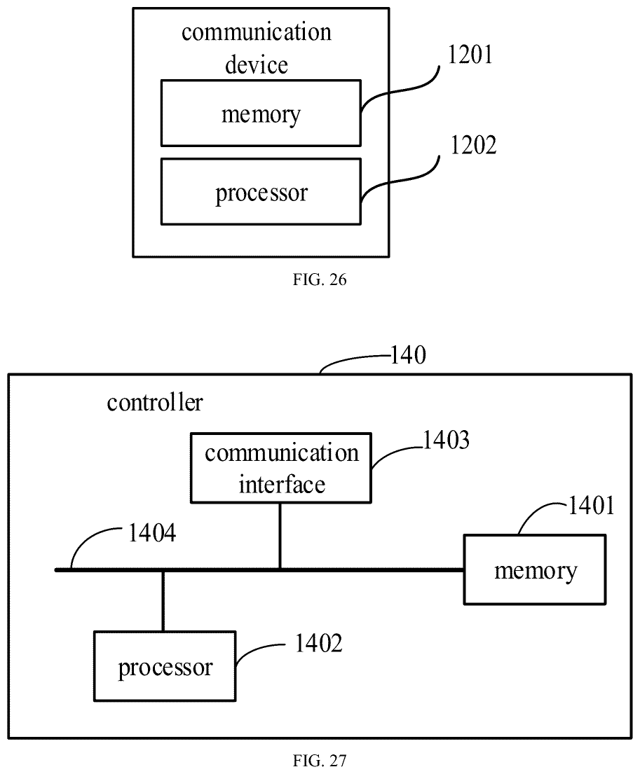

Please referring to FIG. 26, which is a structural diagram of another communication device according to an embodiment of the present application. The present application also provides a communication terminal, the mobile terminal includes a memory 1201, a processor 1202, and a processing program stored in the memory 1201 and executable on the processor 1202, and the processing program is executed by the processor to implement the steps of the processing method in any of the above embodiments.

The present application also provides a computer-readable storage medium, on which a computer program is stored, and the computer program is executed by the processor to implement the steps of the processing method in any of the above embodiments.

In the embodiments of the mobile terminal and computer-readable storage medium provided by the present application, all technical features of the embodiments of the above processing methods are included, and the expansion and explanation of the specification are basically the same as the embodiments of the above call note method, which will not be repeated here.

The present application also provides a computer program product, which includes a computer program code, and when the computer program code is executed on a computer, the computer executes the methods in the above various possible implementations.

The present application also provides a chip, including a memory and a processor, the memory is used to store a computer program, and the processor is used to call and run the computer program from the memory, so that the device equipped with the chip executes the methods in the above various possible implementations.

The present application also provides a computer device for executing the methods in the above various possible implementations.

The computing device generally includes a processor and a memory, and the memory is used to store instructions. When the instructions are executed by the processor, the computing device executes the steps or program modules of the present application.

FIG. 27 is a schematic diagram of a hardware structure of a controller 140 according to the present application. The controller 140 includes a memory 1401 and a processor 1402, and the memory 1401 stores program instructions, and the processor 1402 calls the program instructions in the memory 1401 to execute the steps performed by the controller in the above method embodiment, and its implementation principle and beneficial effects are similar, which will not be repeated herein.

In an embodiment, the above controller further includes a communication interface 1403, which can be connected to the processor 1402 through a bus 1404. The processor 1402 can control the communication interface 1403 to realize the receiving and sending functions of the controller 140.

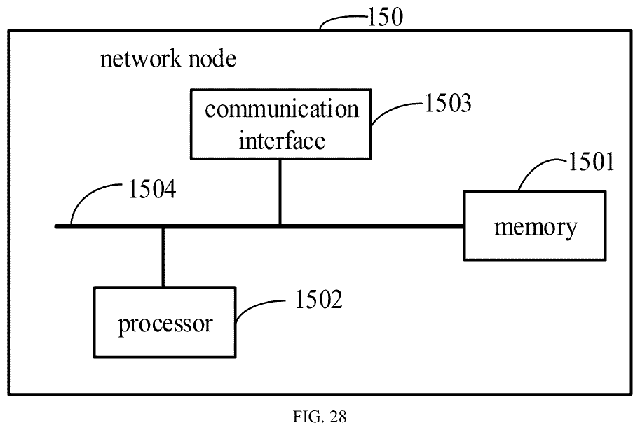

FIG. 28 is a schematic diagram of a hardware structure of a network node 150 according to the present application. The network node 150 includes a memory 1501 and a processor 1502, the memory 1501 stores program instructions, and the processor 1502 calls the program instructions in the memory 1501 to execute the steps performed by the network device in the above-mentioned method embodiment, and its implementation principle and beneficial effects are similar, which will not be repeated herein.

In an embodiment, the above-mentioned network node further includes a communication interface 1503, and the communication interface 1503 can be connected to the processor 1502 through a bus 1504. The processor 1502 can control the communication interface 1503 to realize the receiving and sending functions of the network node 150.

The above-mentioned integrated module implemented in the form of a software function module can be stored in a computer-readable storage medium. The above-mentioned software function module is stored in a storage medium, including several instructions for enabling a computer device (which can be a personal computer, a server, or a network device, etc.) or a processor to perform some steps of the methods of various embodiments of the present application.

In the above embodiments, it can be implemented in whole or in part by software, hardware, firmware, or any combination thereof. When implemented using software, it may be implemented in whole or in part in the form of a computer program product. The computer program product includes one or more computer instructions. When computer program instructions are loaded and executed on a computer, processes or functions according to embodiments of the present application are generated in whole or in part. The computer may be a general purpose computer, a special purpose computer, a computer network, or other programmable device. The computer instruction may be stored in or transmitted from one computer-readable storage medium to another computer-readable storage medium. For example, the computer instruction may be transmitted by wired (e.g., coaxial cable, optical fiber, digital subscriber line) or wireless (e.g., infrared, wireless, microwave, etc.) means from one website, computer, server, or data center to another website, computer, server, or data center. Computer-readable storage media can be any available media that can be accessed by a computer or a data storage device such as a server, data center, or other integrated media that contains one or more available media. Available media may be magnetic media (e.g., floppy disk, storage disk, tape), optical media (e.g., DVD), or semiconductor media (e.g., Solid State Disk (SSD)), etc.

The serial numbers of the embodiments of the present application are only for description and do not represent the advantages and disadvantages of the embodiments.

In the present application, the same or similar terms, concepts, technical solutions and/or application scenario descriptions are generally described in detail only the first time they appear. When it appears again later, for the sake of brevity, it is generally not repeated. When understanding the technical solutions and other content of the present application, the same or similar term concepts, technical solutions and/or application scenario descriptions that are not described in detail later can refer to the relevant previous detailed descriptions.

In the present application, each embodiment is described with its own emphasis. For parts that are not detailed or recorded in a certain embodiment, please refer to the relevant descriptions of other embodiments.

The technical features of the technical solution of the present application can be combined in any way. To simplify the description, all possible combinations of the technical features in the above embodiments are not described. However, as long as there is no contradiction in the combination of these technical features, it should be considered to be within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A processing method, comprising:
determining a contention window size according to feedback information received within a second reference duration, wherein the feedback information comprises at least one of the following: a number of Acknowledgement (ACK) feedbacks, or a ratio of ACK feedbacks; and
determining the second reference duration by a Channel Occupancy Time (COT) position where the most recent transmission with Hybrid Automatic Repeat reQuest (HARQ) feedback enabled.

2. The method according to claim 1, further comprising:
determining the contention window size according to a channel state within a first reference duration and the feedback information received within the second reference duration.

3. The method according to claim 2, wherein:
the channel state comprises at least one of the following: Listen Before Talk (LBT) success, LBT failure, a ratio of LBT failures, and a ratio of sensing slots of busy channels; and
the feedback information further comprises at least one of the following: a number of Negative Acknowledgement (NACK) feedbacks, or a ratio of NACK feedbacks.

4. The method according to claim 2, wherein the determining the contention window size according to the channel state within the first reference duration and the feedback information received within the second reference duration comprises at least one of the following:
in response to that there is no HARQ feedback for a physical sidelink shared channel, adjusting or maintaining the contention window size according to the channel state within the first reference duration; and
in response to that only HARQ-NACK feedback information is received, adjusting the contention window size according to the HARQ-NACK feedback information received within the second reference duration.

5. The method according to claim 4, further comprising at least one of the following:
in response to that LBT fails within the first reference duration, increasing the contention window size;
in response to that the ratio of LBT failures within the first reference duration is greater than a first threshold value, increasing the contention window size;
in response to that the ratio of the sensing slots of busy channels within the first reference duration is greater than a second threshold value, increasing the contention window size;
in response to that LBT succeeds within the first reference duration, maintaining the contention window size, or configuring the contention window size to a minimum contention window size adapted to a channel access priority class;
in response to that the ratio of LBT failures within the first reference duration is less than or equal to the first threshold value, maintaining the contention window size, or configuring the contention window size to the minimum contention window size adapted to the channel access priority class;
in response to that the ratio of the sensing slots of the busy channels within the first reference duration is less than or equal to the second threshold value, maintaining the contention window size, or configuring the contention window size to the minimum contention window size adapted to the channel access priority class;
in response to that the number of NACK feedbacks received within the second reference duration is greater than a fourth threshold value, increasing the contention window size;
in response to that the number of NACK feedbacks received within the second reference duration is less than or equal to the fourth threshold value, maintaining the contention window size, or configuring the contention window size to the minimum contention window size adapted to the channel access priority class;
in response to that the ratio of NACK feedbacks received within the second reference duration is greater than a fifth threshold value, increasing the contention window size; and
in response to that the ratio of NACK feedbacks received within the second reference duration is less than or equal to the fifth threshold value, maintaining the contention window size, or configuring the contention window size to the minimum contention window size adapted to the channel access priority class.

6. The method according to claim 5, wherein the configuring the contention window size to the minimum contention window size adapted to the channel access priority class comprises at least one of the following:
configuring the contention window size to the minimum contention window size of each channel access priority class;
configuring the contention window size to the minimum contention window size of a random channel access priority class;
configuring the contention window size to the contention window size determined by a channel access priority class of a communication device;
configuring the contention window size to the contention window size determined by a channel access priority class of a receiving terminal;
configuring the contention window size to the contention window size determined by a minimum channel access priority class of the receiving terminal;
configuring the contention window size to the contention window size determined by a maximum channel access priority class of the receiving terminal;
configuring the contention window size to the contention window size determined by a random channel access priority class of the receiving terminal; and
configuring the contention window size to the contention window size determined by a channel access priority class corresponding to per-packet priority of near field communication.

7. The method according to claim 2, further comprising at least one of the following:
in response to that an interval between the first reference duration and the currently expected COT is greater than a third threshold value, maintaining the contention window size, or configuring the contention window size to the minimum contention window size adapted to the channel access priority class;
in response to that the interval between the first reference duration and the currently expected COT is less than or equal to the third threshold value, adjusting the contention window size according to the channel state;
in response to that an interval between the second reference duration and the currently expected COT is greater than a sixth threshold value, maintaining the contention window size, or configuring the contention window size to the minimum contention window size adapted to the channel access priority class;
in response to that the interval between the second reference duration and the currently expected COT is less than or equal to the sixth threshold value, adjusting the contention window size according to the received feedback information; and
in response to that a communication device performs a first transmission in an unlicensed spectrum, maintaining the contention window size, or configuring the contention window size to the minimum contention window size adapted to the channel access priority class.

8. The method according to claim 1, wherein a way for determining the first reference duration comprises at least one of the following:
determining the first reference duration by COT position where the most recent transmission is located;
determining the first reference duration by at least one candidate position of the first transmission within the COT where the most recent transmission is located;
determining the first reference duration by N sensing slots corresponding to the contention window associated with the COT where the most recent transmission is located;
determining the first reference duration by the COT position associated with the most recent contention window size update; and
determining the first reference duration by the COT position where the most recent transmission with HARQ feedback enabled;
wherein a way for determining the second reference duration comprises at least one of the following:
determining the second reference duration by COT position where the most recent transmission is located;
determining the second reference duration by the COT position associated with the most recent contention window size update.

9. A communication device, comprising: a memory, a processor, and a processing program stored in the memory and executable on the processor, wherein the processing program implements the processing method according to claim 1 when executed by the processor.

10. A non-transitory computer-readable storage medium, wherein a computer program is stored in the non-transitory computer-readable storage medium, and when the computer program is executed by a processor, the processing method according to claim 1 is implemented.

11. A communication apparatus, comprising:
a processing unit configured for:
determining a contention window size according to feedback information received within a second reference duration, wherein the feedback information comprises at least one of the following: a number of Acknowledgement (ACK) feedbacks, and a ratio of ACK feedbacks; and
the processing unit further for determining the second reference duration by a Channel Occupancy Time (COT) position where the most recent transmission with Hybrid Automatic Repeat reQuest (HARQ) feedback enabled.
